(19) United States
(12) Patent Application Publication
(10) Pub. No.: US 2021/0197457 A1
(43) Pub. Date: Jul. 1, 2021

(54) SOLID-STATE METHODS OF JOINING DISSIMILAR MATERIALS AND PARTS

(71) Applicants: Anita T Broach, Christiansburg, VA (US); Chase Cox, Radford, VA (US); Christopher Garguilo, Blacksburg, VA (US); Nanci Hardwick, Blacksburg, VA (US)

(72) Inventors: Anita T Broach, Christiansburg, VA (US); Chase Cox, Radford, VA (US); Christopher Garguilo, Blacksburg, VA (US); Nanci Hardwick, Blacksburg, VA (US)

(21) Appl. No.: 17/120,929

(22) Filed: Dec. 14, 2020

Related U.S. Application Data
(63) Continuation of application No. PCT/US2019/037968, filed on Jun. 19, 2019.
(60) Provisional application No. 62/686,949, filed on Jun. 19, 2018.
(60) Provisional application No. 62/729,147, filed on Sep. 10, 2018.

(51) Int. Cl. B29C 64/165; B33Y 10/00; B22F 10/14

(52) U.S. Cl. CPC B29C 64/165; B33Y 10/00; B29K 2505/00; B22F 2302/403; B22F 10/14

(57) ABSTRACT

Solid-state additive manufacturing processes for joining dissimilar materials and parts are described. Processes include feeding a first material through a hollow tool of a solid-state additive manufacturing machine to contact a second material, generating deformation of the materials by applying normal, shear and/or frictional forces using a rotating shoulder of the tool such that the materials are in a malleable and/or visco-elastic state in an interface region, and mixing and joining the materials in that region. The joining can include interlocks of various shapes in the interface region. One or multiple taggants can be included in deposited material and/or layers, which taggants respond when triggered by specific external stimulus, such as becoming visible upon subjecting to light of a particular wavelength, heating, electric field, and so on. Some taggants are capable of multiple levels of security effects which can be seen by the naked eye or by using special detectors/readers.

### CROSS-REFERENCE TO RELATED APPLICATIONS

This application is a continuation application of PCT/US2019/037968 filed on Jun. 19, 2019. PCT/US2019/037968 claims priority to and the benefit of the filing dates of U.S. Provisional Application Nos. 62/686,949 (filed on Jun. 19, 2018) and 62/729,147 (filed on Sep. 10, 2018). The disclosure of each of U.S. Provisional Application Nos. 62/686,949 (filed on Jun. 19, 2018) and 62/729,147 (filed on Sep. 10, 2018) is hereby incorporated by reference herein in its entirety.

### BACKGROUND

### Field of the Invention

The present invention provides solid-state additive manufacturing processes for joining dissimilar materials and parts and includes products manufactured using such processes, including products manufactured with one or multiple taggants included in deposited material capable of responding to external stimulus, such as light, heat, and electric field.

### Description of Related Art

Joining of Dissimilar Materials and Parts

The focus towards lightweight parts and structures, especially in the aerospace and automotive industries, has prompted an increased interest and exploitation of lightweight metallic and non-metallic (e.g., polymer, composite) materials while still achieving the functionality of the part/structure. Metal-polymer or metal-composite structures combine the strength and ductility of metal with the chemical resistance, lightweight, high specific strength and elasticity of a polymer. The metal is present in portions where high stiffness and strength are expected, whereas the polymer or composite material is utilized where chemical resistance and light weight is needed, also enabling formation of complex shapes in the molding process.

Among the currently known in the art joining methods for dissimilar materials and parts are: mechanical fastening, adhesive bonding and welding.

Mechanical fastening enables a reliable joint and good joint resistance when joining metal and polymer, usually with rivet joining, but requires an increased number of parts and operation steps. The process itself has limitations due to poor flexibility in terms of joint design, since the joint shape and position is usually fixed mechanically, and the production rate is relatively slow.

Adhesive joining is a relatively simple method with design flexibility. However, this type of joining suffers several disadvantages, such as relatively low mechanical resistance, a limited working temperature range, low resistance in chemically reactive environments, limited long-term durability, and extensive surface preparation requirements. Numerous different types of testing hybrid structures have proven that the adhesive layer is the weakest part of the hybrid structure.

Friction spot and ultrasonic welding are performed in a solid state by mixing of the metal and plastic workpieces at the joint interface. However, these joining methods have only been successfully applied to low melting point metals only (magnesium and aluminum) and the spot welding seems not applicable to thick metal pieces.

Laser welding of metals to polymers can be used to achieve stable metallic, chemical, and covalent bonds between metal and polymer/hybrid components. However, bonding occurs in the molten state-solid state interface between the plastic and metal (as the metal does not melt in this joining process). Due to the rapid expansion (due to high pressure) during the process bubbles are formed, which weaken the interface. Advantages of this process are fast welding times and small heat input, but the limitations of the process are the numerous process parameters (travel speed, welding power) that need tight control and its applicability mainly for lap joints because of the need for effective absorption of the laser beam.

Currently known methods for joining dissimilar materials and structures have serious limitations. Therefore, there is a need of efficient joining methods to join a variety of dissimilar materials and parts and make them mechanically strong and suitable for various engineering applications.

Anti-Counterfeiting Features

Tagging, tracking and locating original materials, parts and products is of crucial importance for many commercial, security and military applications. The primary purpose of an embedded taggant or anti-counterfeit feature is to enable the authentication of the original material (original product) by the manufacturer and by the end user from fake ones (“copies”). The second function of the taggant or anti-counterfeit feature is to act as a deterrent to anyone considering counterfeiting the material/product. However, it is worth mentioning that the taggant or anti-counterfeit feature provides no assurance that the material/product will not be adulterated and might not reduce counterfeit attempts but is designed to make easy detection between the original and fake materials or products, and if needed, to prove the authenticity in the prosecution (infringement) cases.

Taggants (anti-counterfeit features) might involve a number of different effects, such as photo-chemical effects—absorbing energy at one wavelength and emitting energy at another, or just absorbing energy at particular wavelengths and showing a particular color, temporal effects when illuminated with pulsed energy, specific response to heat, or electric or magnetic field, exhibiting different colors when viewing at different angles, etc.

There are many taggant (anti-counterfeit) technologies available to manufacturers, ranging from simple but effective, through more sophisticated to extremely secure. In general, taggant/anti-counterfeit technologies can be classified as:
Overt or visible features, and
Covert or hidden markers.

Overt security features are intended to enable end users to verify the authenticity of a material/product. Such features are usually visible. Wherever overt features are used, very often counterfeiters will apply a simple copy which mimics the original material/part, sufficiently well to confuse the average user. Overt features (taggants) should be applied in such a way that they cannot be reused or removed without being defaced or causing damage to the part. Existing identification techniques (serial number, optical barcode, intaglio features, microscale features and radio frequency devices) have been used widely in overt labeling. For some overt applications, the taggant effect may be readily observable such as the application of materials that change colors with slight temperature changes or when viewed at varying angles or when illuminated by UV or IR light. Color shifting inks, pearlescent inks, visible holograms, watermarks and so on, are just few examples that are also readily apparent to the authenticating party.

Semi-overt security applications, such as thermochromic inks, photochromic inks, chemical markers and micro-printing are also possibilities towards higher security level. For covert applications, the taggant is not readily observable, but special sensing systems are required that operate in conjunction with the triggering (e.g., illumination) source and/or sophisticated algorithms to detect the presence of the taggant(s). The purpose of a covert feature is to enable the manufacturer (brand product owner) to identify counterfeited material or product. Usually, the general public will not be aware of the covert feature presence, nor have the means to verify it. A covert feature should not be easy to detect or copy without “specialist” knowledge, and the feature details should be controlled and limited to certain parties. Covert taggants, such as UV and/or IR responsive materials, magnetic inks, DNA based taggants and specific machine readable taggants are the most advanced covert solutions.

Most of the above mentioned taggants have been mainly developed for the packaging industry to authenticate expensive products such as drugs, vaccines, inks, etc. These taggants can be “easily” used with most plastic materials, paper and other materials. Some of the mentioned taggants cannot survive higher processing temperatures or prolonged processing times, such as the temperature and the time needed for processing metals or building (3D-printing) structures from metals. Solid-state additive manufacturing processes, such as the MELD™ type process, offers the advantage of lower processing temperatures and shorter processing times, since it does not melt the material for its deposition. During the solid-state additive manufacturing process, the material undergoes a plastic deformation due to variety of intense friction and other forces, which results in so-called “malleable” state of the material that consequently can be easily deposited into 3D parts or coatings. Still to deposit the metal, metal alloy or MMC with the solid-state additive manufacturing process, the material could be heated up to 0.8 Tm (where Tm is the melting point of the material) in the solid-state additive manufacturing machine, which temperatures might be high for some of the already developed taggants. Therefore, there is a need of finding a way to add new or known covert and overt taggants to metal materials and metal parts, and if possible, the taggants to be added during the metal manufacturing steps without a need of introducing additional “tagging” steps.

Additive Manufacturing

Additive manufacturing (AM) is defined as the process of making 3D parts (usually layer by layer) and is capable of producing complex parts. Differences, however, can exist between interfacial and non-interfacial microstructures leading to inhomogeneous properties along specific part sites and directions. In such cases, fabricated parts exhibit inferior properties in comparison to the bulk material. In particular, fusion-based AM processes often result in problems associated with melting and solidification such as brittle cast structure, hot cracking and porosity, leading to a reduction in mechanical performance. Furthermore, the coating techniques, such as flame spray, high-velocity oxygen fuel (HVOF), detonation-gun (D-Gun), wire arc and plasma deposition, produce layers or coatings that have considerable porosity, significant oxide content and discrete interfaces between the coating and substrate. Typically, these coating processes operate at relatively high temperatures and melt and oxidize the material as it is deposited onto the substrate. Such techniques are not suitable for processing of many types of substrates and coating metals, such as nanocrystalline materials due to the grain growth and loss of strength resulting from the relatively high processing temperatures. Even the alternative deposition process known as cold spray type depositing, which typically involves a relatively low-temperature spray process in which particles are accelerated through a supersonic nozzle are relatively expensive and generally incapable of processing high aspect ratio particles.

To overcome the above-mentioned shortcomings of metal AM and coating technologies, solid-state additive manufacturing technology, such as MELD™ type manufacturing, was developed. MELD™ type additive manufacturing is an environmentally-friendly system with highly-scalable technology capable of operating in an open atmosphere and producing high deposition rates. The solid-state additive manufacturing process(es) are solid-state thermo-mechanical processes utilizing a unique combination of high forces, mostly friction forces, and frictional heating, which heats and plastically deforms the material to the point at which it freely flows like a liquid. However, the material is not in a liquid state, but in a solid malleable state, below its melting point. Therefore, it is considered as a no-melt additive manufacturing process and offers the advantage of less oxidation, less energy consumption and same or even better mechanical properties in the final built parts than parts made by competing technologies. Moreover, the solid-state additive manufacturing process does not require a vacuum level or inert gas environment or space-limiting powder material bed, usually associated with laser-based 3D printing processes.

The solid-state additive manufacturing process actually “stirs” plastically-deformed, or softened, metal together or into the layer below. In particular, friction forces and material plastic deformation create a unique refined grain structure in the deposited layer and the layer underneath, which is crucial for the mechanical strength in the deposited parts. Because of that, products produced by the solid-state additive manufacturing process have “refined” or smaller grain size than the parent material used. In metals, in general, greater strength, greater corrosion resistance, and greater wear resistance are expected as metal grain size gets smaller. Moreover, the solid-state additive manufacturing process yields a metallurgical bond between the deposited material and the substrate, as well as between the subsequent deposited layers.

MELD™ type solid-state additive manufacturing process(es) also offer the flexibility of using a broad range of material types and material forms yielding a near wrought microstructure on near net shape 3D structures. Multiple materials can be also used as feed materials to produce multi-material parts or functionally-graded parts. So far, metals, metal alloys and metal matrix composites (MMCs) have been successfully used in different solid-state additive manufacturing processes. Due to the solid-state nature of the process, the residual stresses usually generated in the deposited parts are much less (or none) compared to the residual stresses generated during competing 3D printing technologies, metal casting or other manufacturing processes that involve melting and solidification. As it is known, melting metals causes problems. Since there is no melting during the solid-state additive manufacturing process, the parts and structures built with the solid-state additive manufacturing process are stronger in comparison to those manufactured with competing technologies. Products produced by solid-state additive manufacturing process are already fully dense, meaning there are no voids in the deposited materials. With melt-based processes, the additively-manufactured part usually contains small pockets without material (pores), similar to a sponge. Then the parts need to go through a second process during which they are compressed. Finally, they are ready for the last processing steps before they are considered ready. MELD™ type technology, on the other hand, requires no sintering or after-processing of the parts produced by this technology and skips these costly and time-consuming procedures.

### SUMMARY

In this invention disclosure, a solid-state additive manufacturing process is proposed for joining dissimilar materials and parts. Furthermore, the solid-state additive manufacturing technology is proposed for embedding the taggants in metals, MMC and other materials during the deposition (3D printing) without a need of applying additional “tagging” steps. The embodiments below are just examples of the capabilities of the solid-state additive manufacturing system to join dissimilar materials/parts and built large scale and complex 3D hybrid structures as a way towards building lightweight structures in a simplified way compared to competitive technologies. Some of the embodiments will also include the incorporation of taggants in the deposited layers.

Aspects of embodiments of the invention include:

Aspect 1. A process for joining dissimilar materials with a solid-state additive manufacturing machine, comprising: feeding a first material through a hollow tool of a solid-state additive manufacturing machine onto a surface of a second material; generating plastic deformation of the first and second material by applying normal, shear and/or frictional forces by way of a rotating shoulder of the hollow tool such that the first and second material are in a malleable and/or visco-elastic state in an interface region, and mixing and joining the first and second materials in the interface region.

Aspect 2. The process of Aspect 1, wherein the first and second materials are two different polymers.

Aspect 3. The process of any preceding Aspect, wherein the first and second materials are two different metals, MMCs or metal alloys.

Aspect 4. The process of any preceding Aspect, wherein the first material is a polymer and the second material is a metal, or the first material is a metal and the second material is a polymer.

Aspect 5. The process of any preceding Aspect, wherein the polymer penetrates among the grains in a surface region of the metal.

Aspect 6. The process of any preceding Aspect, wherein the first material is a polymer and the second material is a composite material, or wherein the first material is a composite material and the second material is a polymer.

Aspect 7. The process of any preceding Aspect, wherein the first material is a metal and the second material is a composite material, or the first material is a composite material and the second material is a metal.

Aspect 8. The process of any preceding Aspect, wherein the first and second materials are unweldable materials (materials that cannot be welded together).

Aspect 9. The process of any preceding Aspect, wherein the first and second materials are of very low surface energy.

Aspect 10. The process of any preceding Aspect, wherein the first and second materials are joined via formation of one or more interlayers.

Aspect 11. The process of any preceding Aspect, wherein the first material is a liquid crystalline polymer (oligomer), which upon deposition on a surface of the second material is preferentially oriented.

Aspect 12. The process of any preceding Aspect, wherein the first material is a reactive material which upon deposition on top of the second material undergoes a reaction.

Aspect 13. The process of any preceding Aspect, wherein the first material undergoes a reaction with the aid of an initiator.

Aspect 14. The process of any preceding Aspect, wherein the first material undergoes a reaction with the aid of heat, light or electron beam.

Aspect 15. The process of any preceding Aspect, wherein one or both of the first and second materials are doped with dopants and/or reinforcement particles.

Aspect 16. The process of any preceding Aspect, wherein the dopants and/or reinforcement particles are of micron- on nano-sizes.

Aspect 17. The process of any preceding Aspect, wherein the dopants and/or reinforcement particles are micron-size or nano-size fibers.

Aspect 18. The process of any preceding Aspect, wherein the dopants and/or reinforcement particles are carbon nanotubes (CNTs).

Aspect 19. The process of any preceding Aspect, wherein the dopants and/or reinforcement particles are mixtures of more than one type of material.

Aspect 20. The process of any preceding Aspect, wherein the dopants are microcapsules filled with initiator, primer and/or adhesion promoter.

Aspect 21. The process of any preceding Aspect, wherein the dopants and/or reinforcement particles are disposed in a top section of a last layer deposited.

Aspect 22. The process of any preceding Aspect, wherein the dopants and/or reinforcement particles present in a top section of the last layer deposited provide targeted functionality of the surface.

Aspect 23. The process of any preceding Aspect, wherein the dopants are Cu- or Ag-particles or both and provide anti-microbial functionality.

Aspect 24. The process of any preceding Aspect, wherein the dopants provide anti-corrosion functionality.

Aspect 25. The process of any preceding Aspect, wherein the dopants provide anti-wear functionality.

Aspect 26. The process of any preceding Aspect, wherein the dopants and/or reinforcement particles are added only in the interfacial region to one or both of the first and second materials.

Aspect 27. The process of any preceding Aspect, wherein the first and second materials comprise untreated surfaces at the interface region.

Aspect 28. The process of any preceding Aspect, wherein the first and second materials comprise rough surfaces at the interface region.

Aspect 29. The process of any preceding Aspect, wherein the first and second materials comprise treated surfaces at the interface region.

Aspect 30. The process of any preceding Aspect, wherein one or more surfaces are treated with plasma-, corona-, flame-, or ozone-treatment, laser or reactive ion etching or surface functionalization.

Aspect 31. The process of any preceding Aspect, wherein the treated surfaces have increased surface roughness compared to untreated surfaces.

Aspect 32. The process of any preceding Aspect, wherein the interface region comprises interlocks.

Aspect 33. The process of any preceding Aspect, wherein the interlocks comprise any cross-sectional shape including square, rectangular, semi-circle, trapezoid, triangle or dove-tail shape.

Aspect 34. The process of any preceding Aspect, wherein the inter-locks are filled with dopants or reinforcing particles.

Aspect 35. The process of any preceding Aspect, wherein the inter-locks are filled with microcapsules comprising initiator, primer and/or adhesion promoter.

Aspect 36. The process of any preceding Aspect, where the process involves in situ forming of functionally-graded interlayers in the direction of increasing number of layers.

Aspect 37. The process of any preceding Aspect, wherein the interlayers comprise the same materials as the first and second materials.

Aspect 38. The process of any preceding Aspect, wherein the interlayers comprise different materials than the first and second materials.

Aspect 39. The process of any preceding Aspect, wherein the interlayers comprise one or more polymers, composites, or prepregs.

Aspect 40. The process of any preceding Aspect, wherein the surface of the second material comprises one or more grooves and the first material forms interlocks by filling the one or more grooves.

Aspect 41. The process of any preceding Aspect, wherein the grooves are dovetail-shaped.

Aspect 42. The process of any preceding Aspect, wherein the grooves are trapezoidal-shaped.

Aspect 43. The process of any preceding Aspect, wherein the grooves vary in size and periodicity on the surface of the second material.

Aspect 44. The process of any preceding Aspect, wherein successive interlayers form a gradient composition of one or more materials.

Aspect 45. The process of any preceding Aspect, wherein a single layer forms a gradient composition within a single plane.

Aspect 46. The process of any preceding Aspect, wherein one or more of the interlayers are coated.

Aspect 47. The process of any preceding Aspect, wherein the dopants and/or reinforcement particles are present in a concentration gradient spanning successive interlayers.

Aspect 48. A process for joining dissimilar parts with a solid-state additive manufacturing machine, comprising: feeding a filler material through a hollow tool of the solid-state additive manufacturing machine on to a joint between a first and second part to be joined; generating plastic deformation in the surface regions of the first and second part to be joined by applying strong normal, shear and frictional forces by way of a rotating shoulder of the hollow tool such that the surface regions are in a malleable and/or visco-elastic state in an interface region, and mixing and joining the filler material with the surface regions of the first and second part to be joined in the interface region.

Aspect 49. The process of Aspect 48, wherein the first and second part to be joined comprise different materials.

Aspect 50. The process of any of Aspects 48-49, wherein the first and second part to be joined comprise the same material.

Aspect 51. The process of any of Aspects 48-50, wherein the first and second part to be joined comprise metal, polymer, or composite.

Aspect 52. A process for joining dissimilar parts with a solid-state additive manufacturing machine, comprising: feeding a filler material through a hollow tool of the solid-state additive manufacturing machine on top of the first and second part to be joined; generating plastic deformation in the surface regions of the first and second part to be joined by applying strong normal, shear and frictional forces by way of a rotating shoulder of the hollow tool such that the surface regions are in a malleable and/or visco-elastic state in an interface region, and mixing and joining the filler material on a top deposited layer with the surface regions of the first and second part to be joined in the interface region.

Aspect 53. A process of making sandwich panel structures with a solid-state additive manufacturing machine, comprising: adding a second panel with the solid-state additive manufacturing machine on top of a first panel; adding a third panel with the solid-state additive manufacturing machine on top of the second panel, and adding additional panels until the sandwich panel structure is completed.

Aspect 54. A method of manufacturing a solid-state 3D printed layer or object comprising at least one taggant that uniquely responds to an energy emitting source, the method comprising: adding one or more agents to a solid-state additive manufacturing process capable of incorporating the at least one taggant into the solid-state 3D printed layer or object.

Aspect 55. The method of Aspect 54, wherein the solid-state additive manufacturing process comprises: feeding a first material through a hollow spindle or tool of a solid-state additive manufacturing machine; depositing the first material onto a second material, wherein the first material is below its melting point (Tm) during deposition; and generating plastic deformation of the first material by applying normal, shear and/or frictional forces by way of a rotating shoulder of the hollow tool such that the first and second material are in a malleable and/or visco-elastic state in an interface region, thereby producing the resultant solid-state 3D printed layer or object with the incorporated at least one taggant.

Aspect 56. The method of Aspect 54 or 55, wherein the one or more agents are taggant(s) which are added by continuously mixing the taggant(s) with the first material.

Aspect 57. The method of any of Aspects 54-56, wherein the one or more agents are taggant(s) which are added to the first material at discrete time periods.

Aspect 58. The method of any of Aspects 54-57, wherein the one or more agents are taggant(s) which are added to the first material in discrete batches.

Aspect 59. The method of any of Aspects 54-58, wherein the one or more agents generate the at least one taggant in situ during deposition.

Aspect 60. The method of any of Aspects 54-59, wherein the at least one taggant is generated by physical bonding or complexation of the agents.

Aspect 61. The method of any of Aspects 54-60, wherein the at least one taggant is generated by a chemical reaction among the agents.

Aspect 62. The method of any of Aspects 54-61, wherein the energy-emitting source is light generating source.

Aspect 63. The method of any of Aspects 54-62, wherein the energy-emitting source is a heat generating source.

Aspect 64. The method of any of Aspects 54-63, wherein the energy-emitting source is an electric field generating source.

Aspect 65. The method of any of Aspects 54-64, wherein the energy-emitting source is a magnetic field generating source.

Aspect 66. The method of any of Aspects 54-65, further comprising verifying the originality of the solid-state 3D printed layer or object by: subjecting the layer or object to energy from the energy emitting source; and detecting the at least one taggant in the layer or object by way of detecting one or more spectra emitted from the at least one taggant as a result of absorption of the energy or excitation from the energy.

Aspect 67. The method of any of Aspects 54-66, further comprising verifying the originality of the 3D printed layer or object by detection with a microscope.

Aspect 68. The method of any of Aspects 54-67, wherein the at least one taggant comprises an inert taggant capable of being activated by an external device.

Aspect 69. The method of any of Aspects 54-68, wherein the at least one taggant comprises an inert taggant capable of being activated by applying external chemical(s).

Aspect 70. The method of any of Aspects 54-69, wherein the at least one taggant comprises two or more taggants arranged in a particular order along the deposited layer or object.

Aspect 71. The method of any of Aspects 54-70, wherein the at least one taggant comprises two or more taggants which are present in separate layers and are activated only in conjunction/concert with each other.

Aspect 72. The method of any of Aspects 54-71, wherein the at least one taggant has multiple levels of security.

Aspect 73. The method of any of Aspects 54-72, wherein the at least one taggant comprises a single taggant capable of responding to multiple readers (detectors) to reveal hidden information.

Aspect 74. The method of any of Aspects 54-73, wherein the at least one taggant comprises two or more taggants which upon triggering by a single reader reveal multiple levels of secured information.

Aspect 75. The method of any of Aspects 54-75, wherein the at least one taggant comprises two or more taggants which reveal multiple levels of secured information upon being triggered by two or more reading devices.

Aspect 76. The method of any of Aspects 54-75, wherein the at least one taggant comprises a phosphor-type taggant.

Aspect 77. The method of any of Aspects 54-76, wherein the at least one taggant comprises strontium aluminate doped with rare earth metal.

Aspect 78. The method of any of Aspects 54-77, wherein the at least one taggant comprises up-converting phosphor(s).

Aspect 79. The method of any of Aspects 54-78, wherein the at least one taggant emits blue light upon excitation.

Aspect 80. The method of any of Aspects 54-79, wherein the at least one taggant emits green light upon excitation.

Aspect 81. The method of any of Aspects 54-80, wherein the at least one taggant emits red light upon excitation.

Aspect 82. The method of any of Aspects 54-81, wherein the at least one taggant emits white light upon excitation.

Aspect 83. The method of any of Aspects 54-82, wherein the at least one taggant emits yellow light upon excitation.

Aspect 84. The method of any of Aspects 54-83, wherein the at least one taggant emits orange light upon excitation.

Aspect 85. The method of any of Aspects 54-84, wherein the at least one taggant emits indigo (purple) light upon excitation.

Aspect 86. The method of any of Aspects 54-85, wherein the at least one taggant emits multiple colors of light upon excitation.

Aspect 87. The method of any of Aspects 54-86, wherein the at least one taggant comprises distributed taggants which upon light excitation will emit colors in a particular pattern.

Aspect 88. The method of any of Aspects 54-87, wherein the at least one taggant comprises taggant(s) that will act in concert with taggant(s) of other layers revealing a specific color pattern.

Aspect 89. The method of any of Aspects 54-88, wherein the at least one taggant comprises photochromic taggant(s).

Aspect 90. The method of any of Aspects 54-89, wherein the at least one taggant comprises thermochromic taggant(s).

Aspect 91. The method of any of Aspects 54-90, wherein the at least one taggant comprises electrochromic taggant(s).

Aspect 92. The method of any of Aspects 54-91, wherein the at least one taggant comprises two of more taggants that upon a certain triggering action react and exhibit special effects, whether the same or different effects, or both.

Aspect 93. A 3D printed layer or object produced by a method of any preceding Aspect.

Aspect 94. A 3D printed layer or object, where the layer/object comprises at least one taggant that uniquely responds to an energy emitting source.

Aspect 95. The 3D printed layer or object of Aspect 93 or 94, which is produced by a solid-state additive manufacturing process comprising: feeding a first material through a hollow spindle or tool of the solid-state additive manufacturing machine; depositing the first material onto a second material, wherein the first material is below its melting point (Tm) during deposition; and generating plastic deformation of the first material by applying normal, shear and/or frictional forces by way of a rotating shoulder of the hollow tool such that the first and second material are in a malleable and/or visco-elastic state in an interface region, thereby producing the resultant printed layer or object with the incorporated at least one taggant.

Aspect 96. The 3D printed layer or object of any of Aspects 93-95, wherein the one or more taggant is added by continuously mixing the taggant(s) with the first material.

Aspect 97. The 3D printed layer or object of any of Aspects 93-96, wherein the one or more agents are taggant(s) which are added to the first material at discrete time periods.

Aspect 98. The 3D printed layer or object of any of Aspects 93-97, wherein the one or more agents are taggant(s) which are added to the first material in discrete batches.

Aspect 99. The 3D printed layer or object of any of Aspects 93-98, wherein the one or more agents generate the at least one taggant in situ during deposition.

Aspect 100. The 3D printed layer or object of any of Aspects 93-99, wherein the at least one taggant is generated by physical bonding or complexation of the agents.

Aspect 101. The 3D printed layer or object of any of Aspects 93-100, wherein the at least one taggant is generated by a chemical reaction among the agents.

Aspect 102. The 3D printed layer or object of any of Aspects 93-101, wherein the energy-emitting source is light-generating source.

Aspect 103. The 3D printed layer or object of any of Aspects 93-102, wherein the energy-emitting source is a heat-generating source.

Aspect 104. The 3D printed layer or object of any of Aspects 93-103, wherein the energy-emitting source is an electric field generating source.

Aspect 105. The 3D printed layer or object of any of Aspects 93-104, wherein the energy-emitting source is a magnetic field generating source.

Aspect 106. The 3D printed layer or object of any of Aspects 93-105, which is capable of verification of its originality by a method comprising: subjecting the layer or object to energy from the energy emitting source; and detecting the at least one taggant in the layer or object by way of detecting one or more spectra emitted from the at least one taggant as a result of absorption of the energy or excitation from the energy.

Aspect 107. The 3D printed layer or object of any of Aspects 93-106, which is capable of verification of its originality by detection of the at least one taggant with a microscope.

Aspect 108. The 3D printed layer or object of any of Aspects 93-107, wherein the at least one taggant comprises an inert taggant that is capable of being activated by an external device.

Aspect 109. The 3D printed layer or object of any of Aspects 93-108, wherein the at least one taggant comprises an inert taggant that is capable of being activated by applying external chemical(s).

Aspect 110. The 3D printed layer or object of any of Aspects 93-109, wherein the at least one taggant comprises two or more taggants arranged in a particular order along the deposited layer or object.

Aspect 111. The 3D printed layer or object of any of Aspects 93-110, wherein the at least one taggant comprises two or more taggants which are present in separate layers and are activated only in conjunction/concert with each other.

Aspect 112. The 3D printed layer or object of any of Aspects 93-111, wherein the at least one taggant has multiple levels of security.

Aspect 113. The 3D printed layer or object of any of Aspects 93-112, wherein the at least one taggant comprises a single taggant capable of responding to multiple readers (detectors) to reveal hidden information.

Aspect 114. The 3D printed layer or object of any of Aspects 93-113, wherein the at least one taggant comprises two or more taggants which upon triggering by a single reader reveal multiple levels of secured information.

Aspect 115. The 3D printed layer or object of any of Aspects 93-114, wherein the at least one taggant comprises two or more taggants which reveal multiple levels of secured information upon being triggered by two or more reading devices.

Aspect 116. The 3D printed layer or object of any of Aspects 93-115, wherein the at least one taggant comprises a phosphor-type taggant.

Aspect 117. The 3D printed layer or object of any of Aspects 93-116, wherein the at least one taggant comprises strontium aluminate doped with rare earth metal.

Aspect 118. The 3D printed layer or object of any of Aspects 93-117, wherein the at least one taggant comprises up-converting phosphor(s).

Aspect 119. The 3D printed layer or object of any of Aspects 93-118, wherein the at least one taggant emits blue light upon excitation.

Aspect 120. The 3D printed layer or object of any of Aspects 93-119, wherein the at least one taggant emits green light upon excitation.

Aspect 121. The 3D printed layer or object of any of Aspects 93-120, wherein the at least one taggant emits red light upon excitation.

Aspect 122. The 3D printed layer or object of any of Aspects 93-121, wherein the at least one taggant emits white light upon excitation.

Aspect 123. The 3D printed layer or object of any of Aspects 93-122, wherein the at least one taggant emits yellow light upon excitation.

Aspect 124. The 3D printed layer or object of any of Aspects 93-123, wherein the at least one taggant emits orange light upon excitation.

Aspect 125. The 3D printed layer or object of any of Aspects 93-124, wherein the at least one taggant emits indigo (purple) light upon excitation.

Aspect 126. The 3D printed layer or object of any of Aspects 93-125, wherein the at least one taggant emits multiple colors of light upon excitation.

Aspect 127. The 3D printed layer or object of any of Aspects 93-126, wherein the at least one taggant comprises distributed taggants which upon light excitation will emit colors in a particular pattern.

Aspect 128. The 3D printed layer or object of any of Aspects 93-127, wherein the at least one taggant comprises taggant(s) that will act in concert with taggant(s) of other layers revealing a specific color pattern.

Aspect 129. The 3D printed layer or object of any of Aspects 93-128, wherein the at least one taggant comprises photochromic taggant(s).

Aspect 130. The 3D printed layer or object of any of Aspects 93-129, wherein the at least one taggant comprises thermochromic taggant(s).

Aspect 131. The 3D printed layer or object of any of Aspects 93-130, wherein the at least one taggant comprises electrochromic taggant(s).

Aspect 132. The 3D printed layer or object of any of Aspects 93-131, wherein the at least one taggant comprises two of more taggants that upon a certain triggering action react and exhibit special effects.

Aspect 133. The 3D printed layer or object of any of Aspects 93-132, which is a MELD™ type 3D printed layer or object.

### BRIEF DESCRIPTION OF THE DRAWINGS

The accompanying drawings illustrate certain aspects of embodiments of the present invention and should not be used to limit the invention. Together with the written description the drawings serve to explain certain principles of the invention.

FIGS. 1A-G are schematic diagrams showing different materials joined by a solid-state additive manufacturing process, where FIG. 1A shows plastic to metal joining; FIG. 1B shows metal to plastic joining; FIG. 1C shows dissimilar plastics joining; FIG. 1D shows dissimilar metals (such as not-weldable metals) joining; FIG. 1E shows plastic-composite-metal joining; FIG. 1F shows plastics-prepreg-metal joining; FIG. 1G shows plastic-functional interface/interlayer-metal joining, where the functional interface (interlayer) is produced in situ by way of a solid-state additive manufacturing process.

FIGS. 2A-B are schematic diagrams showing lightweight sandwich structures including metal-plastic-metal structures (FIG. 2A) and multiple metal-plastic-metal stack structures (FIG. 2B) fabricated with solid-state additive manufacturing joining process.

FIGS. 3A-E are schematic diagrams showing solid-state additive manufacturing joining of metal and plastic parts with over-coated metal layer (FIGS. 3A, 3B) or plastic layer (FIGS. 3C, 3D) layer, while FIG. 3E shows solid-state additive manufacturing joining of metal, composite and/or plastic parts with metal, composite or polymer overlayer.

FIGS. 4A and 4B are schematic diagrams showing cross-section views of structures fabricated by way of solid-state additive manufacturing joining of plastic to metal and metal to plastic, respectively, using inter-locks.

FIGS. 4C, 4D and 4E are schematic diagrams of solid-state additive manufacturing joining by way of functional interlocks.

FIGS. 5A, 5B, 5C, 5D, 5E, 5F, 5G, 5H, 5I, 5J, 5K, 5L and 5M are schematic diagrams showing cross-section views of different interlock shapes including dovetail-type and other interlocks.

FIGS. 5N, 5O, 5P, and 5Q are schematic diagrams showing cross-section views of trapezoidal interlocks that vary in size and periodicity along the surface. Periodic or non-periodic (random) interlocks are possible.

FIG. 6 is a schematic diagram showing a cross-section of multi-layer stack of dissimilar materials joined by solid-state additive manufacturing technology by way of dovetail-type inter-locks.

FIG. 7A is a schematic diagram showing a cross-section of joining two dissimilar materials (e.g., metal and plastic) by way of fabrication of gradient inter-layers by solid-state additive manufacturing technology. Any number of gradient inter-layers is possible.

FIG. 7B is a schematic diagram showing a cross-section of joining two dissimilar materials (e.g., metal and plastic) by way of fabrication of gradient inter-layers by solid-state additive manufacturing, where thickness of one or more layers can vary.

FIG. 7C is a schematic diagram showing a cross-section of joining two dissimilar materials (e.g., metal and plastic) with dovetail-type inter-locks by way of fabrication of gradient inter-layers by solid-state additive manufacturing technology. Any number of gradient inter-layers is possible; their thickness can be the same or can vary.

FIG. 7D is a schematic diagram showing gradient composition along the deposited layer thickness, where the composition changes smoothly within a single layer and not as discrete layers.

FIG. 7E is a schematic diagram showing gradient composition along the transverse (in plane) direction of filler material deposition by way of a solid-state additive manufacturing process.

FIG. 8 is a schematic diagram showing an example of potential functional interlayers to enhance the bonding between the metal and polymer (plastic).

FIG. 9A is a schematic diagram showing solid-state additive manufacturing coating of a polymeric layer on a metal substrate. During solid-state additive manufacturing process, the viscoelastic thermoplastic polymer mixes with the malleable metal surface; depending on the type of polymer and metal involved, the polymer chains enter the space among the metal grains at the interface.

FIG. 9B is a schematic diagram showing solid-state additive manufacturing deposition of liquid crystalline polymer (LCP). During the deposition process, preferential orientation of LCP chains occurs yielding deposits with anisotropic properties.

FIG. 9C is a schematic diagram showing solid-state additive manufacturing deposition of oligomeric (or monomer or prepolymer) formulation. During the deposition process, external heat and/or light (UV, Visible and/or IR light) and/or e-beam is utilized to facilitate the curing (cross-linking) process and yield cross-linked thermoset structures.

FIG. 9D is a schematic diagram showing solid-state additive manufacturing deposition of one material on the surface of the second material, and these materials are hard to join by conventional joining methods. The surface of the second material is activated by an external source (UV or visible or IR light, or heat or e-beam) and then the first material is deposited on such activated surface. The activated species act as catalysts to promote the reaction and/or bonding at the interface between two materials.

FIGS. 10A, 10B and 10C are schematic diagrams showing polymer composite materials that can be in situ formulated and consequently deposited by the solid-state additive manufacturing process(es).

FIG. 10D is a schematic diagram showing MMCs that can be in situ formulated and deposited by the solid-state additive manufacturing process(es).

FIG. 10E is a schematic diagram showing reinforcing fibers added at the interface between two dissimilar materials joined by solid-state additive manufacturing process. Other reinforcers (beside fibers) can be added to strengthen the bonding between two materials.

FIG. 10F is a schematic diagram showing reinforcing fibers added at the interface region between two dissimilar materials joined by way of inter-locks and a solid-state additive manufacturing process.

FIGS. 11A-D are schematic diagrams showing functionally-graded solid-state additive manufacturing structures, where besides the material composition gradient, a gradient in the dopants' (reinforcements') concentration exist. FIG. 11A shows dopant/reinforcing particles gradient, while FIG. 11B shows in situ tailoring of two types of dopant/reinforcement particles to provide targeted properties in the deposited layers, e.g. anti-corrosion, anti-wear, or anti-microbial activity. As an example, one of the dopants/reinforcers could provide the strength of the structure, while the second dopant could provide the desired anti-corrosion or anti-wear or anti-microbial functionality. FIG. 11C shows reinforcing fibers' gradient in addition to the matrix material composition gradient, while FIG. 11D shows reinforcing particles' gradient without matrix material composition gradient.

FIG. 12A is a schematic diagram showing surface treatment of the substrate to provide better adhesion with the subsequent layer to be deposited by solid-state additive manufacturing.

FIG. 12B is a schematic diagram showing a cross-section of the treated surface from FIG. 12A, yielding etched surfaces with increased roughness.

FIGS. 12C and 12D are schematic diagrams showing the solid-state additive manufacturing process of adding a material (e.g. polymer) on etched surfaces (plasma-, corona-, or laser-treated surfaces).

FIGS. 13A and 13B are scanning electron microscope images of the interface region between copper (Cu) and aluminum (Al) layers taken at 1280× (FIG. 13A) and 4000× (FIG. 13B) magnification.

FIGS. 13C, 13D, 13E and 13F are a drawing (FIG. 13C) and scanning electron microscope images of the interface between steel and aluminum (Al) layers joined by way of square-type interlocks.

FIGS. 13G, 13H, 13I and 13J are a photograph (FIG. 13G), a drawing (FIG. 13H) and scanning electron microscope images of the interface between steel and aluminum (Al) layers joined via dovetail-type interlocks.

FIG. 13K is a scanning electron microscope image of the interface between steel and aluminum (Al) layers.

FIG. 13L is a scanning electron microscope image of the interface (joining) between steel and aluminum (Al) layer, where the joining is via formation of intermetallic layer.

FIG. 13M is a scanning electron microscope image of the interface (joining) between steel and aluminum (Al) layers, where the joining is via mechanical blending interlayer.

FIGS. 14A-D are schematics of a solid-state 3D printed layer with one type of taggant incorporated in situ in the layer exhibiting multiple levels of security. FIG. 14A is a schematic of a solid-state printed layer with embedded taggant (invisible) and not triggered by any external stimuli.

FIG. 14B is a schematic of embedded taggant's effects when triggered by an external stimulus, e.g. light of particular wavelength, while FIG. 14C is a schematic of embedded taggant's effects, when triggered by another external stimulus, e.g. heat. FIG. 14D is a schematic of the embedded taggant effects when the layer is triggered simultaneously by two external stimuli, e.g. light and heat.

FIGS. 15A-E are schematics of a solid-state 3D printed layer with two types of embedded taggants in the layer exhibiting multiple levels of security. FIG. 15A is a schematic of a solid-state printed layer with the embedded taggants (invisible) and not triggered by any external stimuli. FIG. 15B is a schematic of embedded first taggant's effects when triggered by an external stimulus, e.g. light of particular wavelength, while FIG. 15C is a schematic of embedded second taggant's effects, when triggered by external stimulus, e.g. heat. FIG. 15D is a schematic of both of the embedded taggants' effects when the layer is triggered simultaneously by two external stimuli, e.g. light and heat. FIG. 15E is a schematic of both of the embedded taggants' effects when the layer is triggered by external stimuli, different than those in FIGS. 15B-D, e.g. a light of a different wavelength to which both taggants respond with different effects than those presented in FIGS. 15B-D.

FIG. 16A is an example of absorption (excitation) and emission spectra of a phosphor, where the emission (fluorescence or phosphorescence) occurs at higher wavelengths than the excitation wavelength.

FIG. 16B is an example of a spectra of an up-converting phosphor, where excitation is at longer wave-lengths than the emission wavelengths.

FIG. 16C is an example of emission spectra of Eu2+ in different strontium aluminates, all measured at 300 K, except material (5) measured at 4 K due to strong thermal quenching. (D. Dutczak et al., Eu2+ luminescence in strontium aluminates, Phys. Chem. Chem. Phys., 2015, 17, 15236-15249).

FIGS. 17A-C are schematic presentations showing detection (“reading”) of the information hidden in solid-state additively manufactured/3D printed layers in cases when: The taggant is distributed in particular layers only (FIG. 17A); Different taggants are added to specific solid-state additively-generated layers, such as phosphors of specific emission spectra (colors) added to particular layers (FIG. 17B); Different taggants are added along the solid-state additive manufactured layer, such as phosphors of specific emission spectra (colors) added at certain zones during the layer deposition (FIG. 17C).

FIG. 18A is a photograph of a solid-state additively-manufactured aluminum piece (partially surface finished) with embedded taggant.

FIGS. 18B and 18C are photographs of the aluminum piece from FIG. 18A being triggered (irradiated) with a laser light pen (wavelength 405 nm, power <5 mW) for few seconds.

FIGS. 18D, 18E, 18F and 18G are photographs (taken in dark) of the same aluminum piece from FIG. 18A after being irradiated with the laser pen light and showing phosphorescent effects.

FIG. 19 is a schematic diagram showing potential tracking of objects produced by the solid-state additive manufactured process in a battlefield with e.g. IR-sensing device. The objects comprising IR-emitting or IR absorbing taggants are constituent parts of e.g. ammunition (bullets), riffles, helmets, vests, military vehicles, etc. and are being detected by triggering by IR light.

### DETAILED DESCRIPTION

Reference will be made in detail to various exemplary embodiments of the invention. It is to be understood that the following text with exemplary embodiments is not intended as a limitation on the invention. Rather, the following text is provided to give the reader a more detailed understanding of certain aspects and features of the invention. With reference to the figures, the preferred embodiments of the present invention will be herein described for illustrative purposes, to illustrate the particular idea of the invention, and by no means as limitations. Any combination of different embodiments can be used, as well. For example, the word “primary” is intended only to suggest that other embodiments may be defined in terms of their relation to the embodiment initially described; it is not meant to indicate a preference for or the superiority of the presented version. As used herein, the term “coating material” is used interchangeably with “filler material” and “feedstock material”; each relate to an additive material which is fed through a throat of a rotating stirring tool as described in this disclosure. The additive material can also be referred to interchangeably as a “consumable” material.

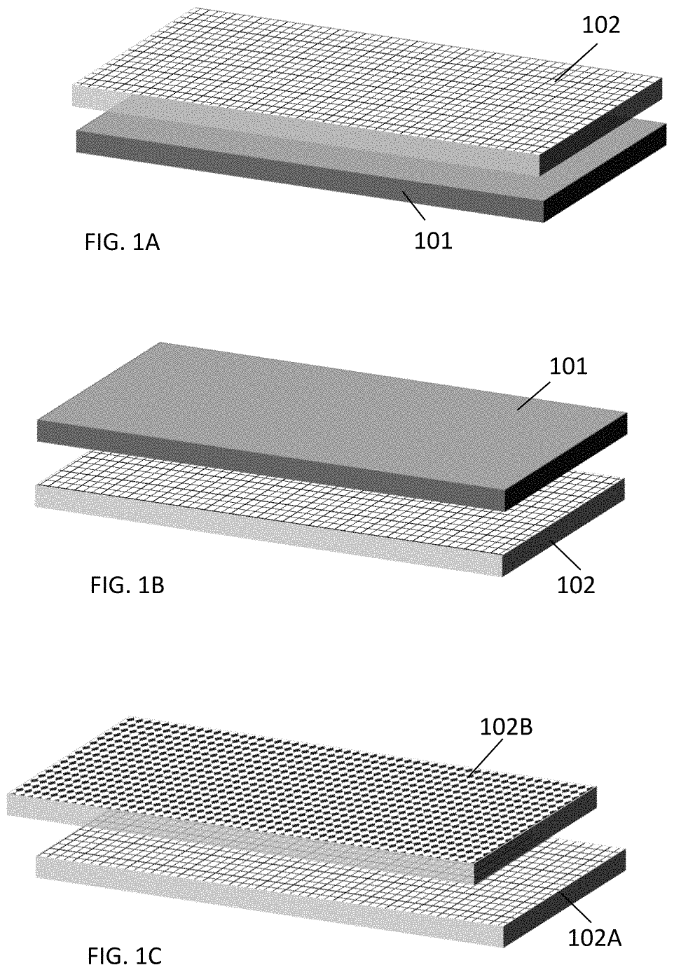

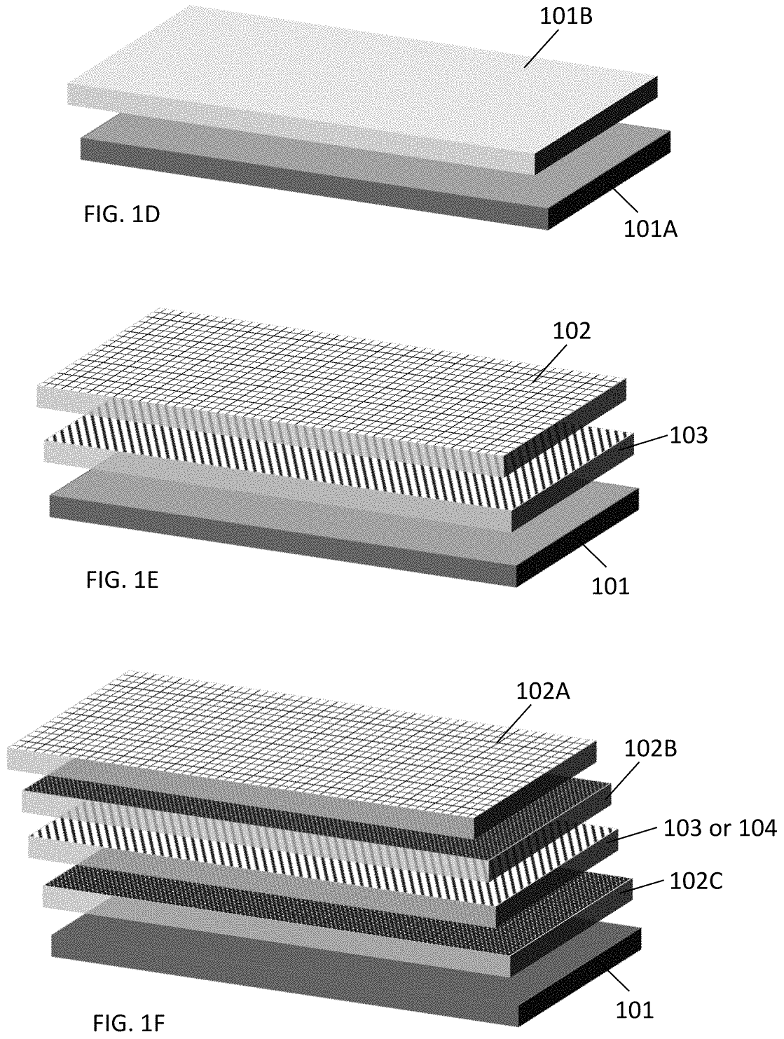

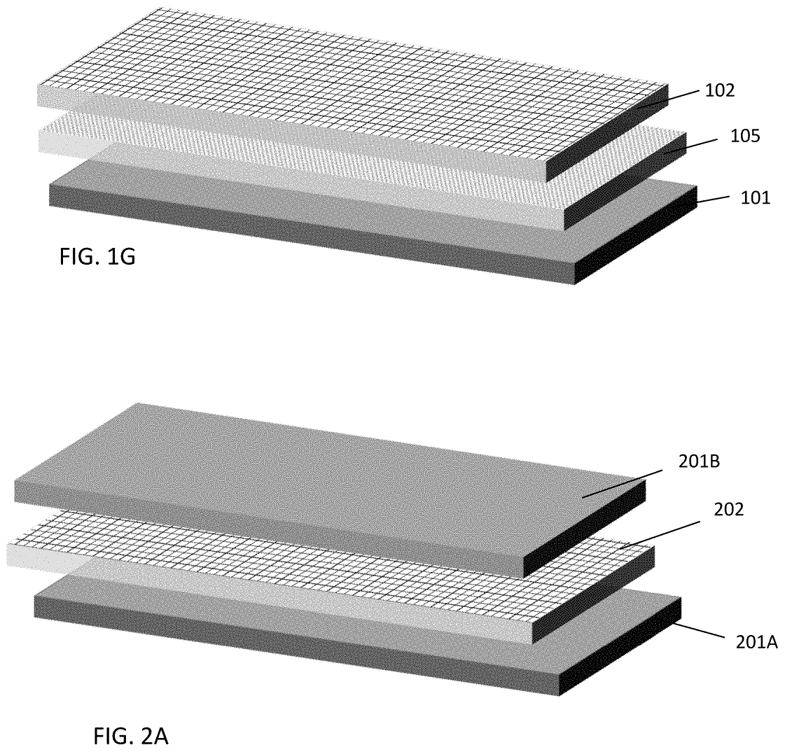

In certain embodiments two dissimilar materials, e.g. polymer (plastic) 102 to metal 101 or metal 101 to polymer (plastics) 102 are joined together with the solid-state additive manufacturing process (FIGS. 1A and 1B). In other embodiments two dissimilar polymers (plastics) 102A and 102B are joined together (FIG. 1C). In yet another embodiment, two dissimilar metals (or metal alloys or MMCs or any combination of them) 101A and 101B, or metals that cannot be welded together, are joined together (FIG. 1D).

In some embodiments, the joining process occurs between a substrate 101 and a layer 102 deposited by the solid-state additive manufacturing process, while in other embodiments, both, 101 and 102, are layers deposited by the solid-state additive manufacturing process.

In some embodiments, the plastic 102 is joined to the metal 101 by way of an inter-layer, where the inter-layer is a composite layer 103 (FIG. 1E). The composite layer 103 is composed of: (i) both materials, the polymer and the metal, in a form of e.g. metal fibers or metal particles dispersed in a polymer matrix, or (ii) carbon fibers or glass fibers dispersed in polymer matrix, or (iii) composition of other dissimilar materials.

In other embodiments, there are two or more interlayers involved between the metal 101 and the plastic 102A to be joined together (FIG. 1F). The interlayer stack is composed of but not limited to: plastic 102B/prepreg 104/plastic 102C, or plastic 102A/composite 103/plastic 102B, and where top plastic material 102A and the plastic interlayers 102B and 102C are the same or different types of plastics.

In some embodiments, the interphase interlayer 105 is formed in situ by the solid-state additive manufacturing process and is different than the previously described interlayers (FIG. 1G). In another embodiment, the interface 105 is made by surface functionalization of the surface(s) that need to be joined by the solid-state additive manufacturing. As example only, such interface 105 is produced by in situ chemical reaction of the chemical species found on the surface of the material 101 need to be bonded with the material 102, when the species are in contact with the species of the material 102 or when they are exposed to elevated temperatures and/or friction forces.

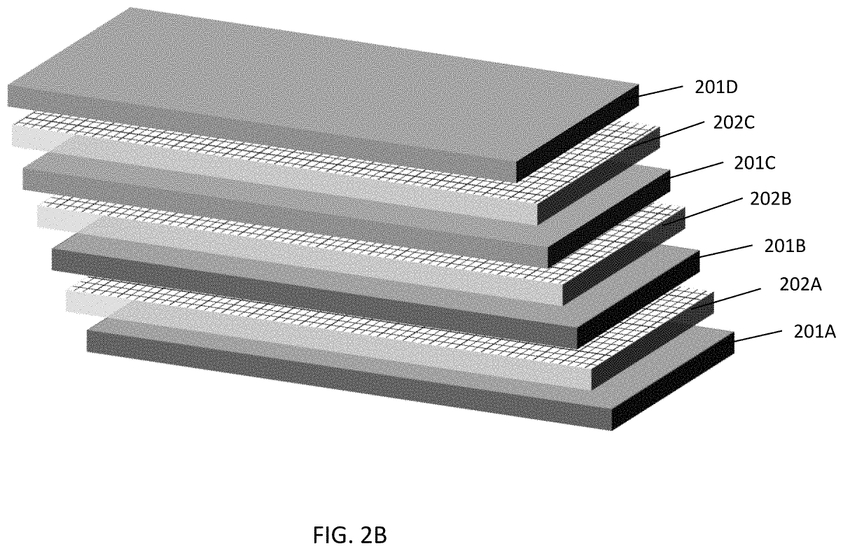

In some embodiments, sandwich structures, comprising but not limited to metal 201A/plastic 202/metal 201B (FIG. 2A) or multiple stacks of metal 201A/plastic 202A/metal 201B/plastic 202B/metal 201C/plastic 202C/metal 201D/(FIG. 2B), as ways toward lightweight structures, which are replacing bulk metal structures, are fabricated via solid-state additive manufacturing processes.

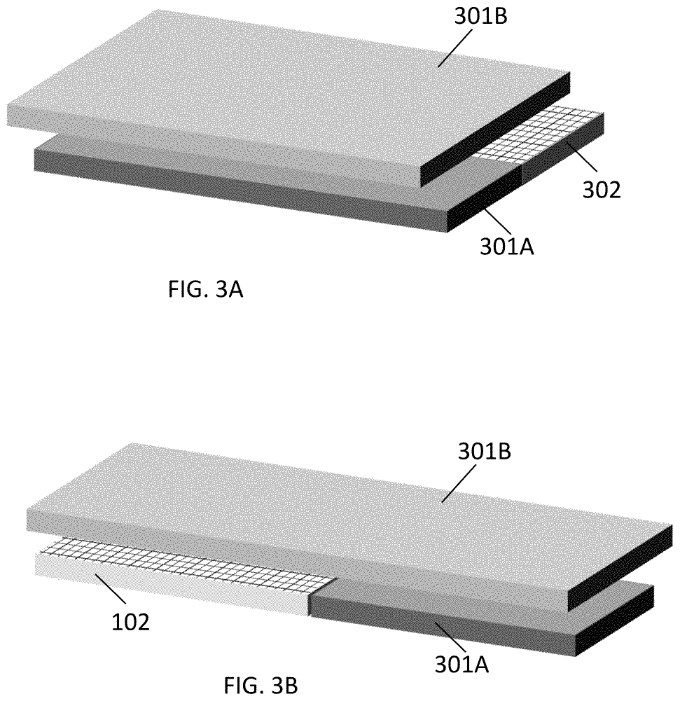

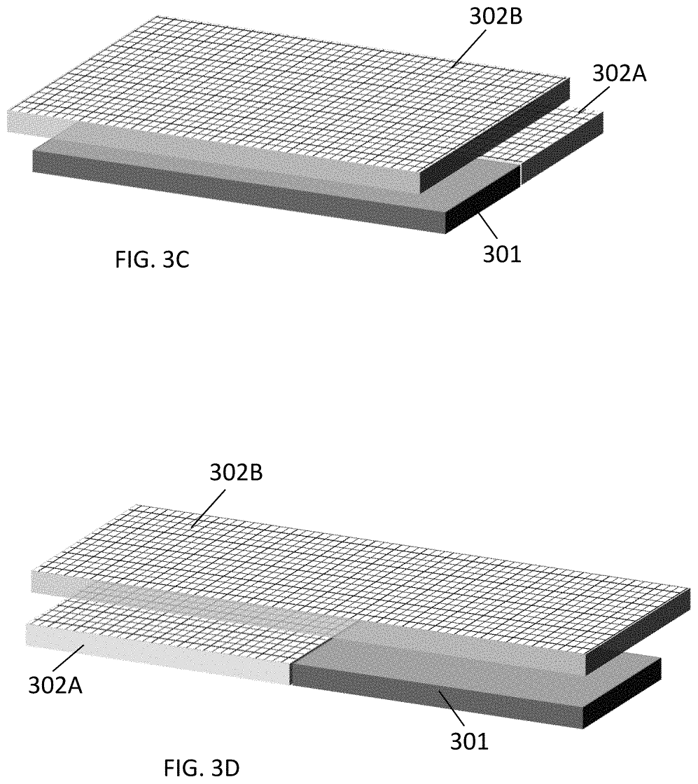

In specific embodiments, dissimilar parts are joined via solid-state additive manufacturing processes. As example only, already made metal part (e.g. plate, sheet) 301A and plastic part (plate, sheet) 302 are joined together side by side or arranged in any other way and overcoated with top metal layer 301B by a solid-state additive manufacturing process (FIGS. 3A and 3B). In another embodiment, the metal part 301 and the plastic part 302A are put close together and joined by coating a plastic overlayer 302B with solid-state additive manufacturing system, as presented in FIGS. 3C and 3D. In yet another embodiment, variety of parts, metal parts 301A, 301B, 301C, plastic parts 302A, 302B, 302C and a composite part 303 are joined together by overcoating a metal layer 301D by a solid-state additive manufacturing (FIG. 3E). In yet other embodiments, various shapes and sizes of multiple plastic, composite, prepreg and/or metal parts are joined together with overlayer deposited by the solid-state additive manufacturing. The deposited overlayer can be metal, plastic or composite layer.

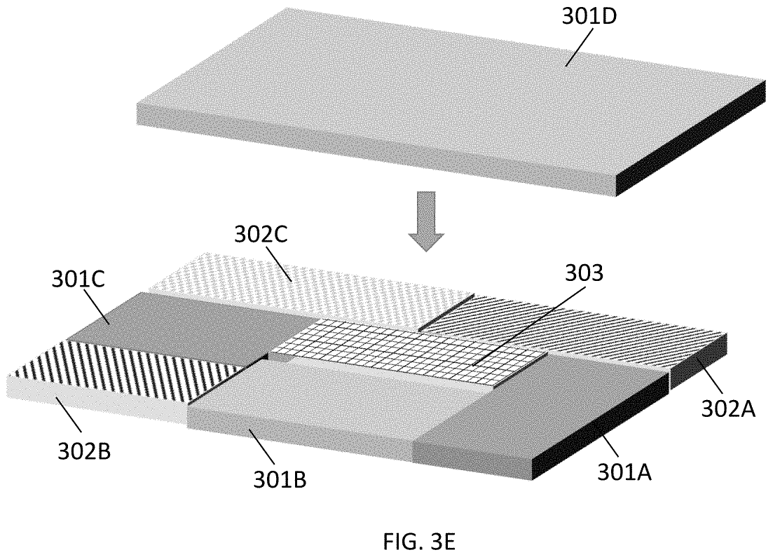

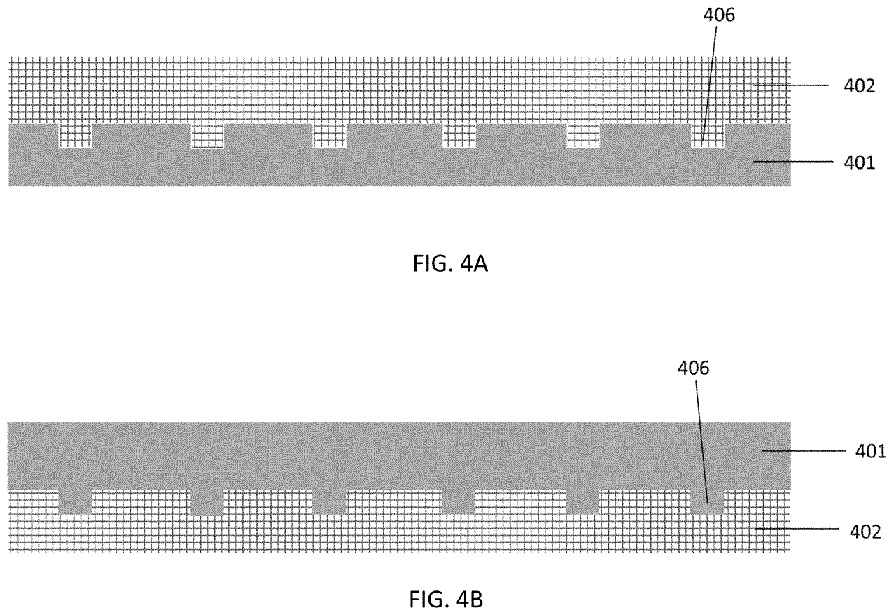

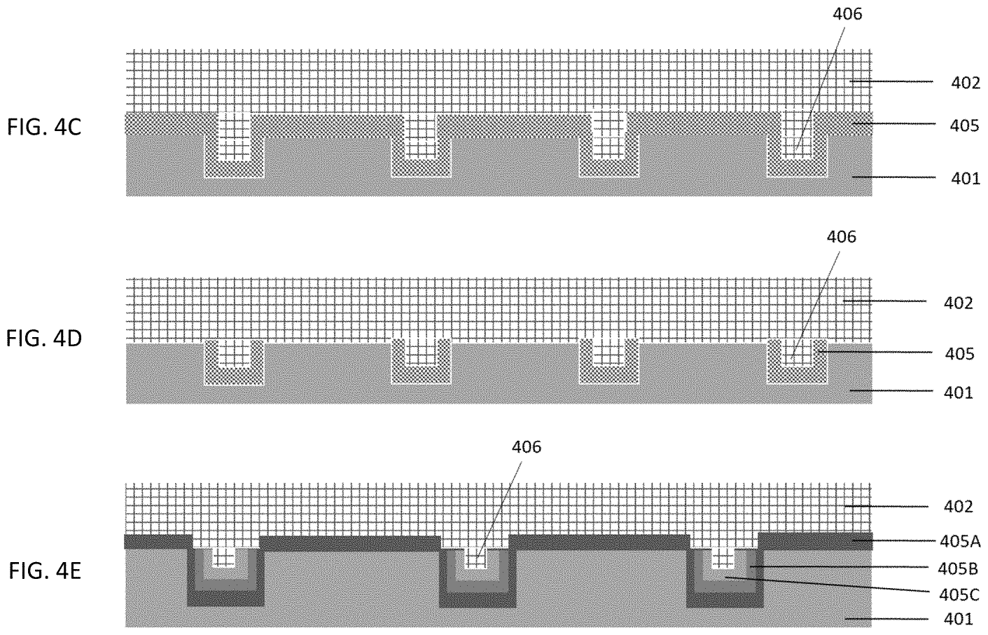

In one embodiment, the solid-state additive manufacturing joining is performed in the presence of interlocks. The interlocks 406 can be in the metal part 401 (FIG. 4A) subjected to the solid-state additive joining process, and the plastic layer 402 is being added, or the interlocks 406 can be in the plastic part 402 that is being overcoated with a metal layer 401 by the solid-state additive manufacturing process (FIG. 4B).

Furthermore, in some embodiments, the interlocks are additionally functionalized to provide better bonding between the two materials needed to be joined. For this purpose, the interlocks 406 are subjected to a treatment (chemical or physical treatment, or combination of both) to functionalize the interlocks' surface, and thus, form one functionalized layer 405 or multiple-layer functionalized interfaces 405A, 405B, 405C, which strengthen the bonding between the two materials or parts 401 and 402 to be joined (FIGS. 4C, 4D and 4E).

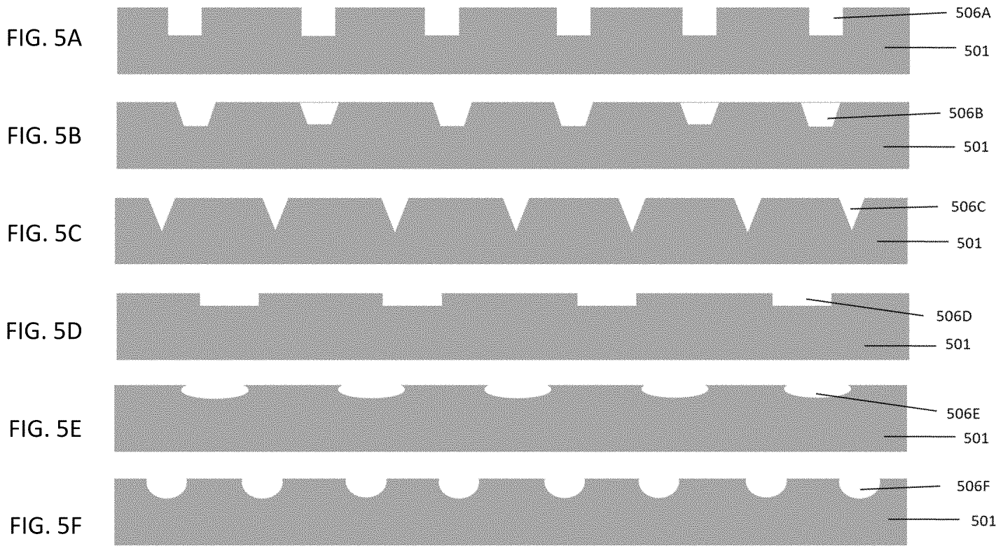

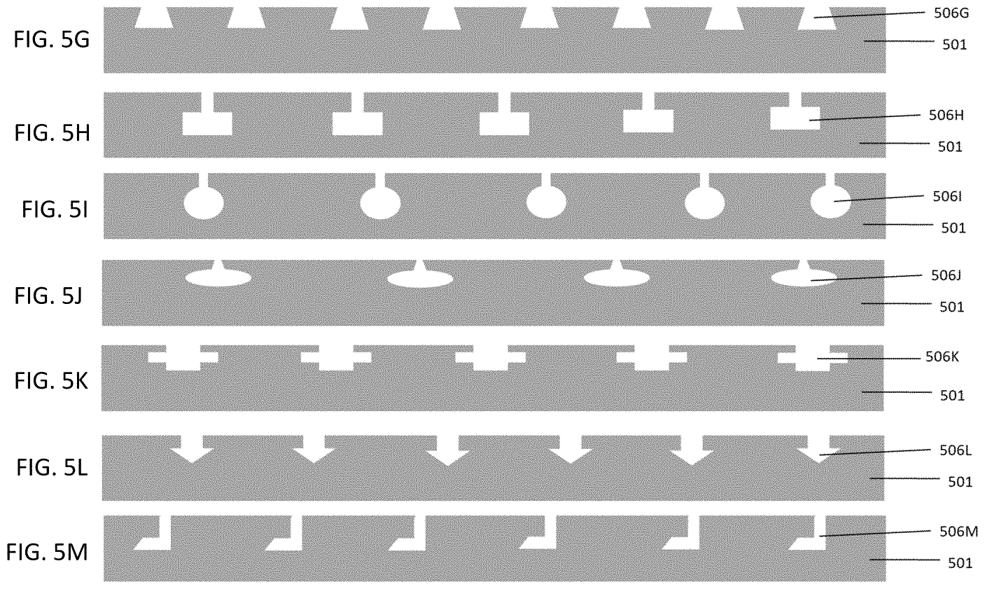

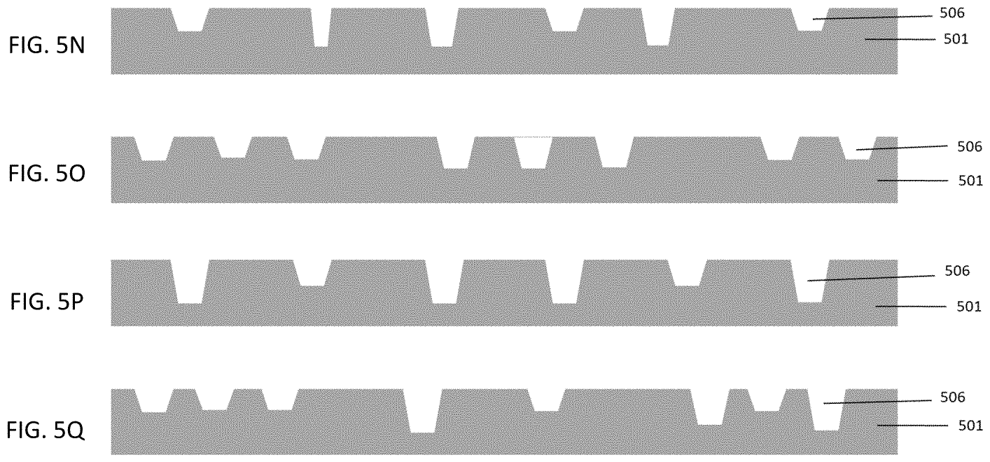

In some embodiments, the inter-locks can be of any shape, size and periodicity; some are presented in FIGS. 5A-5C. The interlocks 506A, 506B, 506C, 506D, 506E, 506F made in e.g. metal substrate 501 could enable better bonding with the overlayer (metal or plastic) deposited by solid-state additive manufacturing (FIGS. 5A-5F). The interlocks like 506G, 506H, 506I, 506J, 506K, 506L and 506M, presented in FIGS. 5B-5M, are preferred embodiments in this invention.

For example, dovetail-like interlocks 506G are the preferred interlocks in this invention, because they could provide better joining between two dissimilar materials needed to be joined. Furthermore, in some embodiments, the interlocks 506 could be the same or could vary in size, shape and depth along the surface of the layer 501 needed to be joined with a dissimilar overcoated material (FIGS. 5N, 5O, 5P and 5Q). In another embodiment, the interlocks are periodic and yet in another embodiment the interlocks appear non-periodically along the surface of the layer 501.

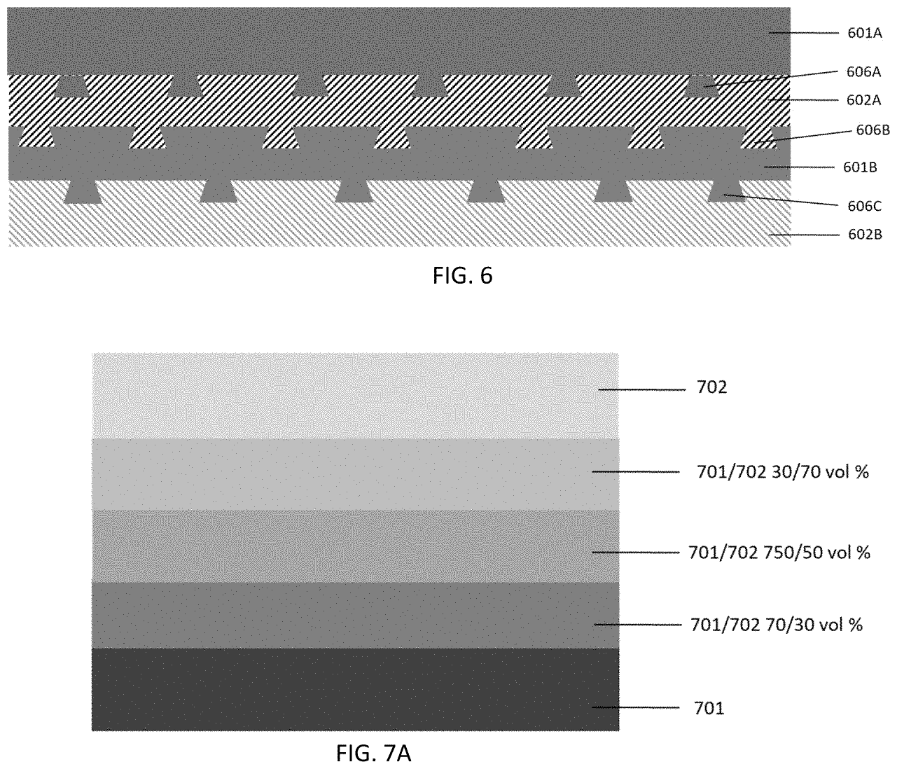

In one embodiment, the stack of multi-layers, all deposited via the solid-state additive manufacturing process, is fabricated. The individual layers in the stack are joined without interlocks. In another embodiment, the individual layers 601A, 602A, 601B, 602B, are joined via interlocks 606A, 606B and 606C, which can be different from one layer to another or the same, as presented in FIG. 6.

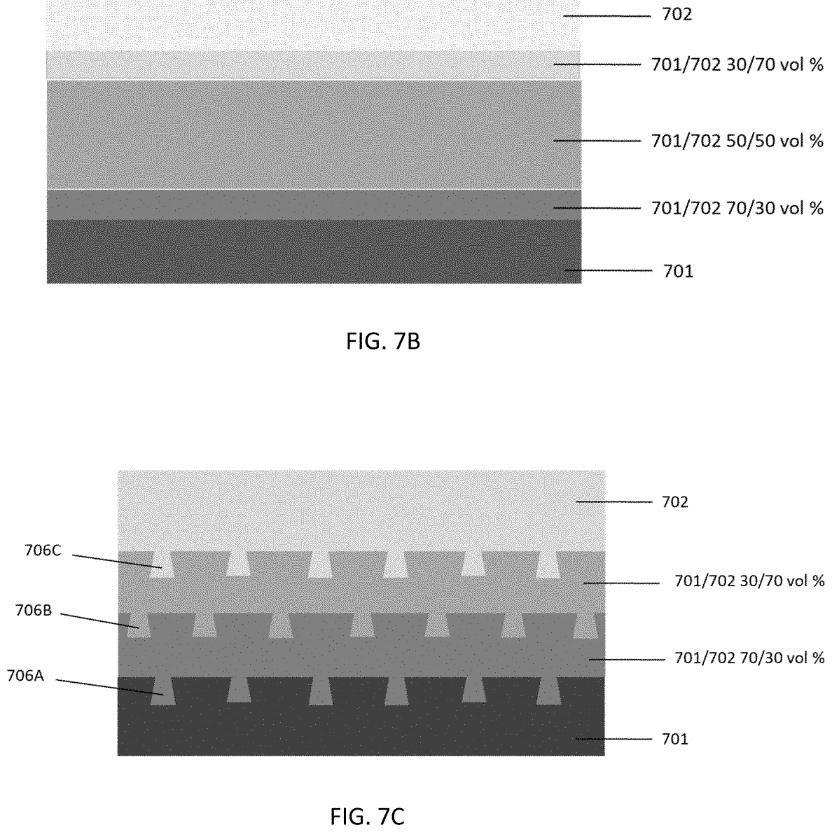

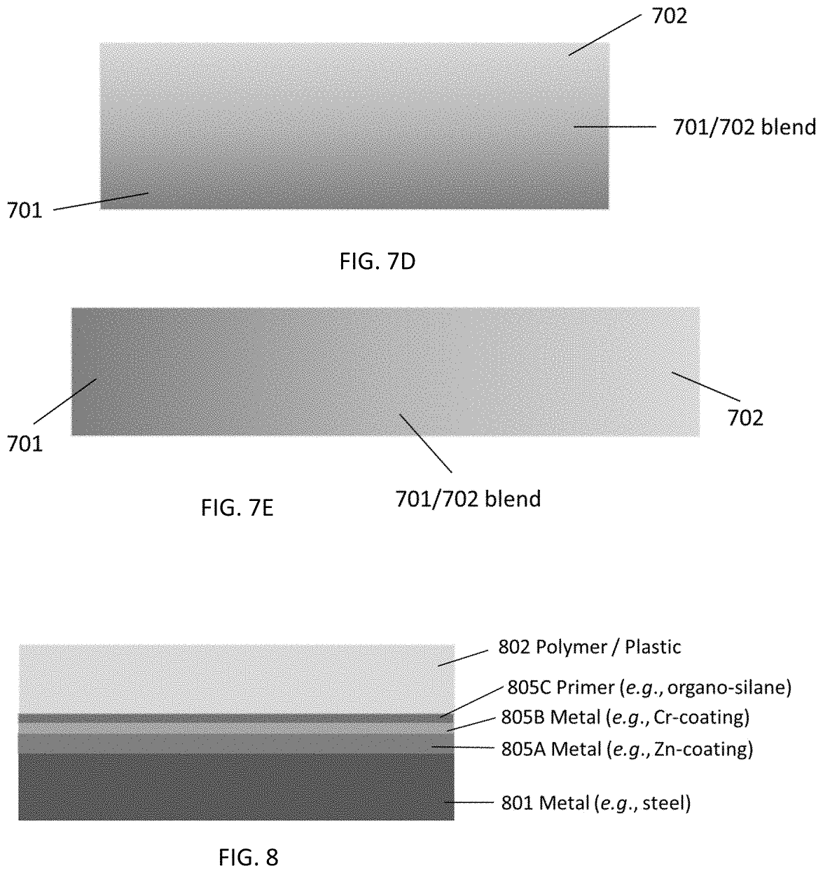

In some embodiments, the consequent layer deposition by the solid-state additive manufacturing process can be done by changing the material composition, and thus, generating a functional gradient composition along the direction of increasing the number of layers (FIGS. 7A and 7B). For instance, the first layer is metal 701 that needs to be joined to plastic 702. With the aid of the solid-state additive manufacturing system, interlayers with 701/702 mixture compositions are deposited. The compositions could be, but not limited to 701/702 70/30 vol %, 50/50 vol % and 30/70 vol %. In certain embodiments, the layers to be joined 701 and 702, as well as 701/702 mixture interlayers, could be with the same thickness (FIG. 7A), or in other embodiments, they could be with different thicknesses (FIG. 7B). In some embodiments, the joining between the layers 701, 702 and 701/702 mixture interlayers could be with the aid of inter-locks 706A, 706B and 706C (FIG. 7C). Any number of functionally-graded interlayers is possible between the materials needed to be joined.

These interlayers can be any of the following compositions ranging from 701/702 99.9/0.1 vol % to 701/702 0.1/99.9 vol %, preferably in the range between 701/702 99/1 vol % and 701/702 1/99 vol %, and more preferred in the range between 701/702 95/5 vol % to 701/702 5/99 vol %, such as 10/90 vol % to 90/10 vol %, or 20/80 vol % to 80/20 vol %, or such as 30/70 vol % to 70/30 vol %, or 40/60 vol % to 60/40 vol %, or 50/50 vol %, or any range within any one or more or combinations of these ranges and/or endpoints. The functionally-graded interlayers can be of the same or different thickness (FIG. 7A).

In certain embodiments, the functional grading occurs along the thickness of the deposited layers, but the composition changes smoothly and not as discrete layers (FIG. 7D). In some embodiments, the functional grading can be done in the transverse direction of the solid-state additive manufacturing deposition, as presented in FIG. 7E.

In some embodiments the solid-state additive manufacturing joining between two dissimilar materials, metal 801 and plastic 802, is done via interlayers, different than those described in the previous embodiments, as presented in FIG. 8. As an example only, a polymer layer 802 is joined to a steel substrate 801 via Zn-based coating 805A deposited on the substrate 801, then Cr-based coating 805B is deposited, which is then over-coated with a hybrid coating e.g. organo-silane primer 805C, and finally the polymer layer 802 is deposited by the solid-state additive manufacturing process. In certain embodiments, the interlayers 805 are added with the same solid-state additive manufacturing system as the main layers 801 and 802 are deposited with. In other embodiments, the main layers 801 and 802 are deposited by the solid-state additive manufacturing, while the interlayers 805 are deposited by other processes known in the art, e.g. magnetron sputtering, thermal evaporation, e-beam evaporation, spray coating, spin-coating, knife coating, dip-coating, etc.

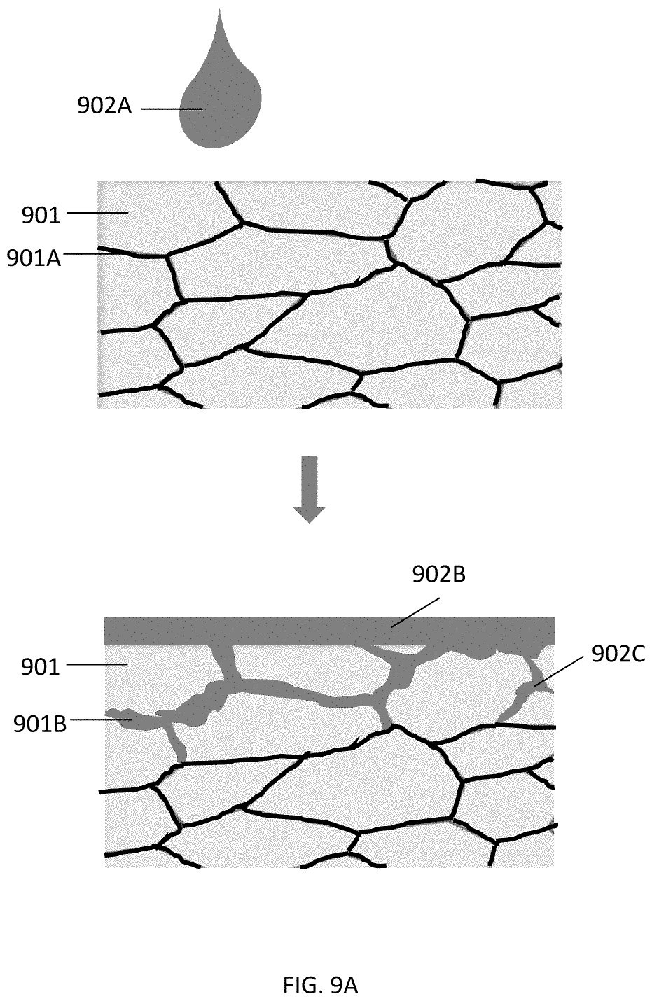

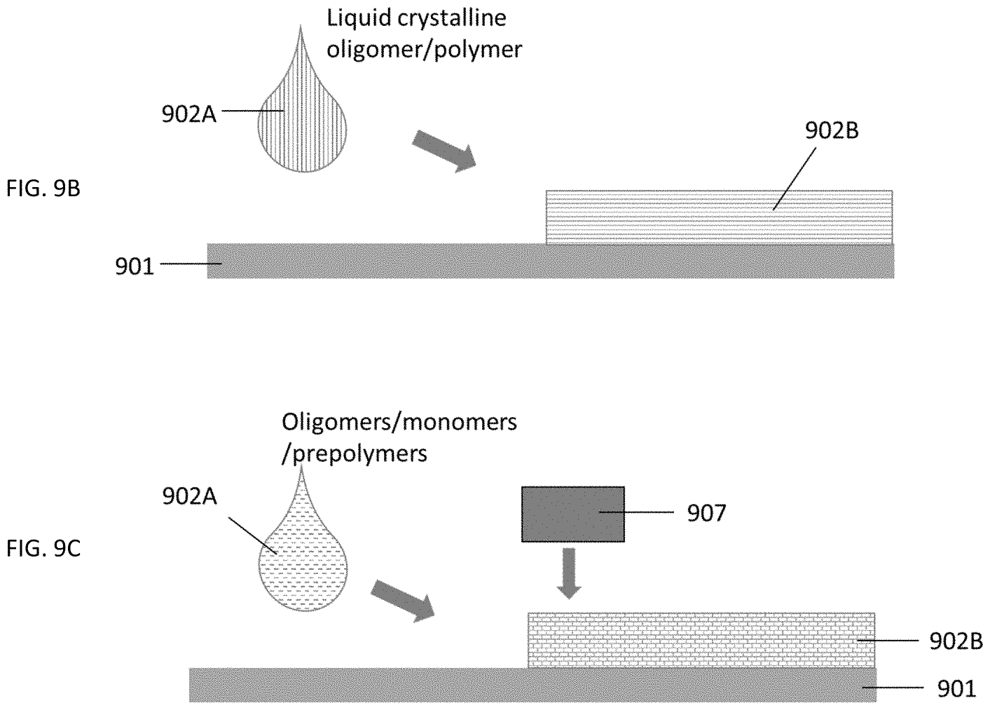

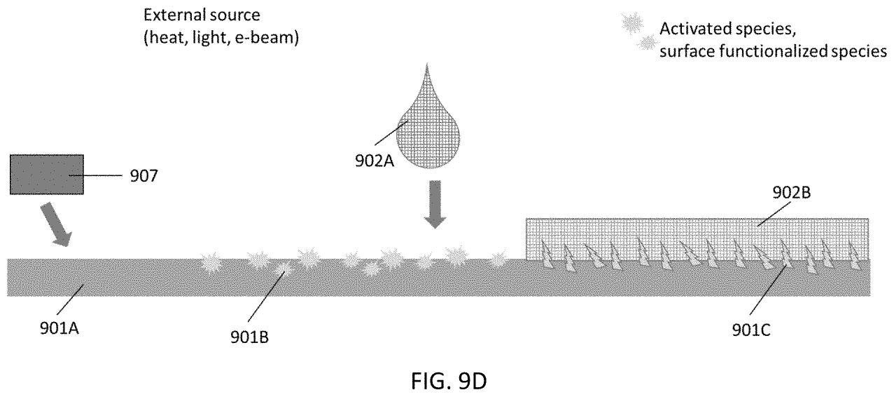

In some embodiments, the easily-flowing polymer composition (or monomer, oligomer, prepolymer composition) 902A, which during the solid-state additive manufacturing process is in the so-called visco-elastic state, can penetrate (diffuse) among the metal grains 901A of the metal part (substrate) 901 that needs to be joined with the polymer layer 902B (FIG. 9A). Depending on the polymer (oligomer, monomer) and metal type involved in the solid-state additive manufacturing joining process, the polymer diffusion 901B among the intrinsic metal grains (lattices) or rearranged metal grains (lattices) during the solid-state process might occur. Since the metal is in the so-called malleable state, the polymer (oligomer, monomer) molecules can diffuse among the metal grains during the solid-state additive manufacturing process and act as an adhesive for the overlaying bulk polymer layer 902B to the metal layer 901 (FIG. 9A).

In another embodiment, a liquid crystalline polymer (LCP) or LC oligomer 902A is employed and deposited on a metal substrate (or part) 901 by the solid-state additive manufacturing process. The rod-like molecular structure of LCP might enables preferential orientation of the LCP molecules during the solid-state additive manufacturing process yielding a layer 902B with anisotropic properties, e.g. directional mechanical properties (FIG. 9B).

In some embodiments, reactive compositions are used for deposition by the solid-state additive manufacturing process. As example only, such reactive composition could be composed of reactive polymers, prepolymers, oligomers and/or monomers and initiators 902A (FIG. 9C). The reactive composition is added in the solid-state additive manufacturing system and during the deposition on a substrate, e.g. metal substrate 901 due to the friction and generated frictional heat, the composition further cross-links and forms a highly cross-linked coating (thermoset coating) 902B on top of the substrate 901.

In another embodiment, the deposited material 902A might be irradiated with an external source, e.g. UV light, visible light, IR light and/or electron beam (e-beam) source 907, to further cross-link the deposited material 902A on the surface of a substrate 901A into a cross-linked layer 902B (FIG. 9D). In yet another embodiment, the deposited reactive composition 902A undergoes a reaction catalyzed by the species 901B found on the surface of substrate 901A on which the material 902A is deposited onto. For instance, ions from the surface 901B act as catalysts for the deposited reactive composition 902A and form bonds 901C between the two materials in situ. The final layer 902B is strongly bonded to the substrate 901A with the bonds 901C (FIG. 9D).

In yet another embodiment, the surface of the substrate 901A on which a second material 902A is being deposited on, is previously activated by heat, light or e-beam generated from the source 907, and the activated species on the surface 901B act as catalysts for the deposited layer 902B or as bonds between the two layers (FIG. 9D).

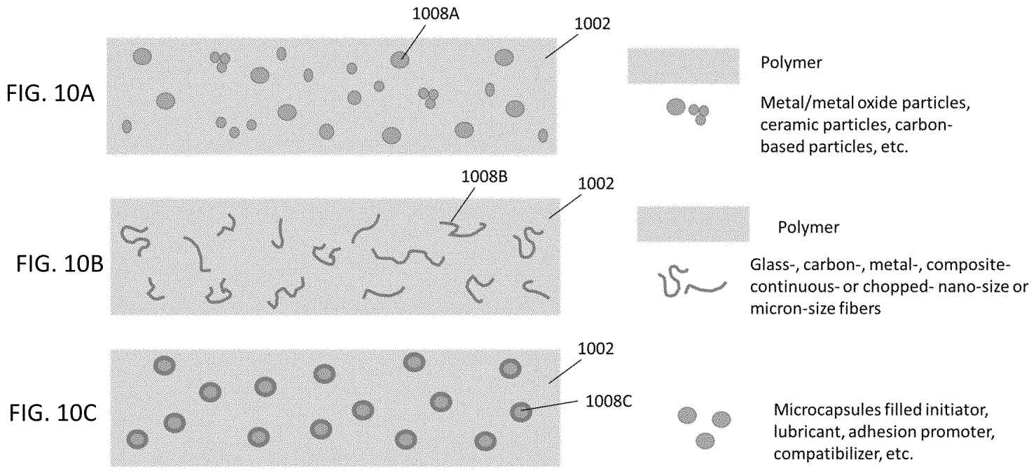

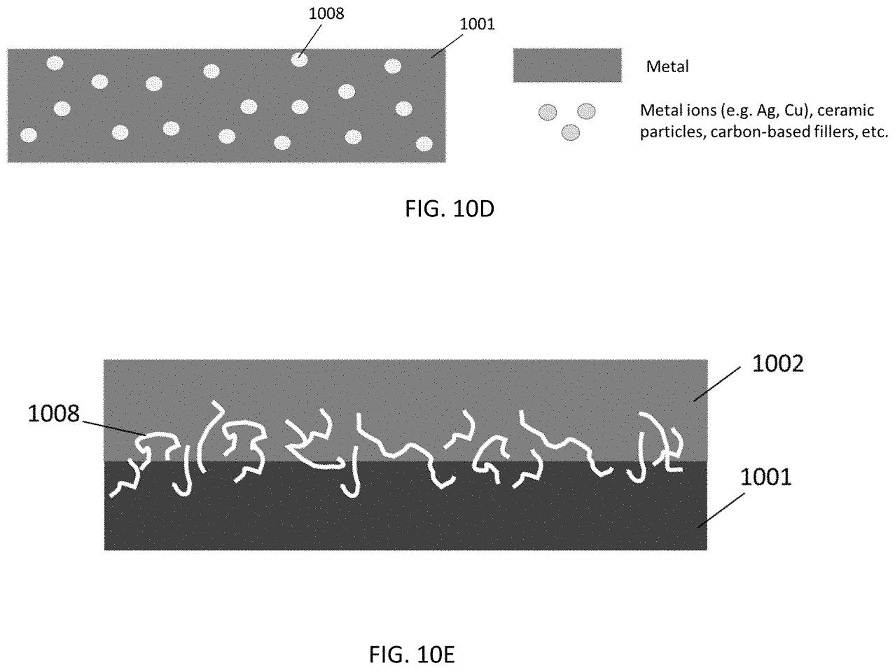

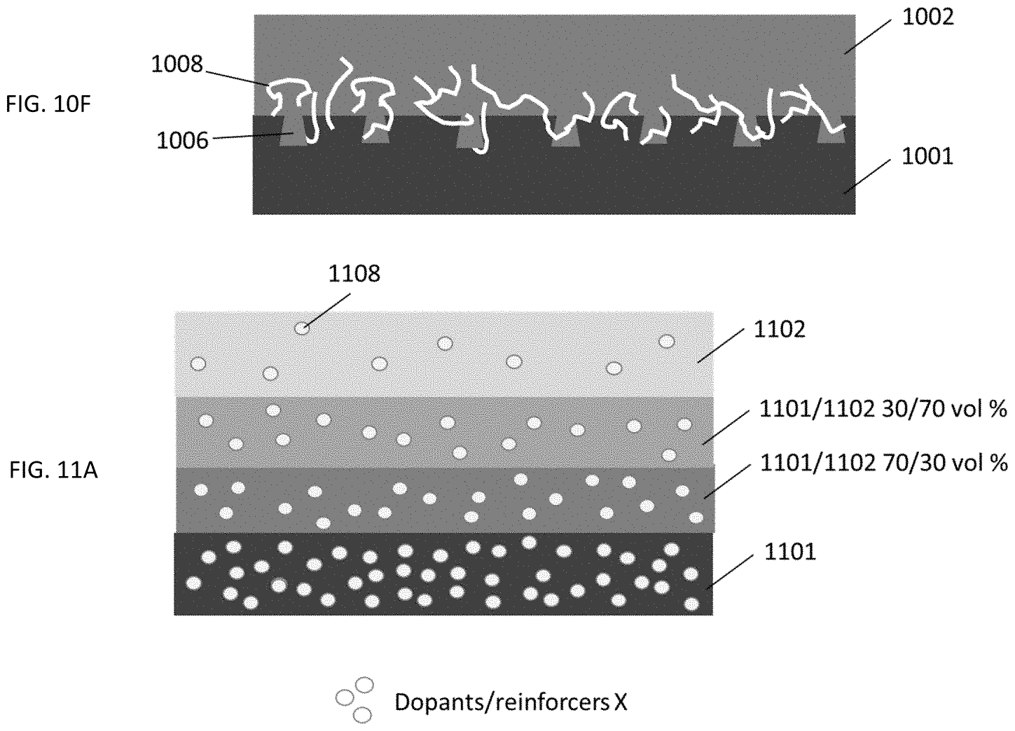

In some embodiments, dopants, reinforcing particles and or fibers 1008A, 1008B and/or 1008C are used to strengthen the polymer 1002 that need to be joined to a dissimilar material (FIGS. 10A, 10B and 10C). For example, the polymer material 1002 is doped with reinforcing particles 1008A, such as metal/metal oxide particles, ceramic particles, carbon-based particles, etc. (FIG. 10A). Another example (FIG. 10B) is when the polymer material is doped with fiber-like reinforcers 1008B, such as glass fibers, carbon fibers, metal fibers or composite fibers (e.g. Aramid, PAN, etc.). The fibers can be continuous fibers or chopped fibers with nano-size or micron-size dimensions. In yet another example, the reinforcers are carbon nanotubes (CNTs), which can be single-wall, double-wall or multi-wall CNTs. In one embodiment, the reinforcers are polymer-wrapped CNTs. In yet another embodiment, functionalized fibers serve as reinforcers.

In some embodiments, the dopants are microcapsules 1008C filled with reactive compounds or compounds having certain activity (FIG. 10C). As example only, the dopants are microcapsules 1008C filled with thermal initiator to cause additional cross-linking during the solid-state additive manufacturing deposition of the polymer material 1002. In another example, the dopants are microcapsules 1008C filled with an adhesion promoter to provide better adhesion between the polymer and metal material to be joined. In yet another example, the microcapsules 1008C are filled with liquid lubricant or compatibilizer in order to provide better mixing and compatibility between the polymer and metal materials.

In another embodiment, the dopants/reinforcers 1008 are added to the metal material 1001 (FIG. 10D). The dopants/reinforcers 1008 can be other metal particles added to the matrix metal 1001 (e.g. stainless steel). As an example, the particles 1008 are such particles that are able to release Ag or Cu ions, and thus, yield anti-microbial functionality of the metal layer (stainless steel) 1001. In another embodiment, the particles 1008 are ceramic particles, e.g. SiC or BN, added to provide a reinforcing effect to the meta matrix 1001. In yet another example, the particles 1008 are carbon-based particles, e.g. carbon fibers, CNTs, carbon black to provide reinforcing effect and electrical conductivity. In another example, the particles 1008 are fiber-like dopants.

In some embodiments, fiber-like reinforcers 1008 are used to strengthen the individual layers and/or the interface between the two consecutive dissimilar layers. The surface region of the material that it is deposited on and the added filler material are in a so-called malleable state during the solid-state additive deposition process and both materials are mixed together. The fiber reinforcers are mixed with both materials in the interface region and will further strengthen the interface. In another embodiment, the fiber-like dopants 1008 are added during the solid-state deposition process only at the interface between the two dissimilar materials, e.g. metal 1001 and polymer 1002 (FIG. 10E) to provide additional strength at the interface. In another embodiment, the interface has inter-locks 1006 and the reinforcing fibers 1008 are added in the inter-locks (FIG. 10F).

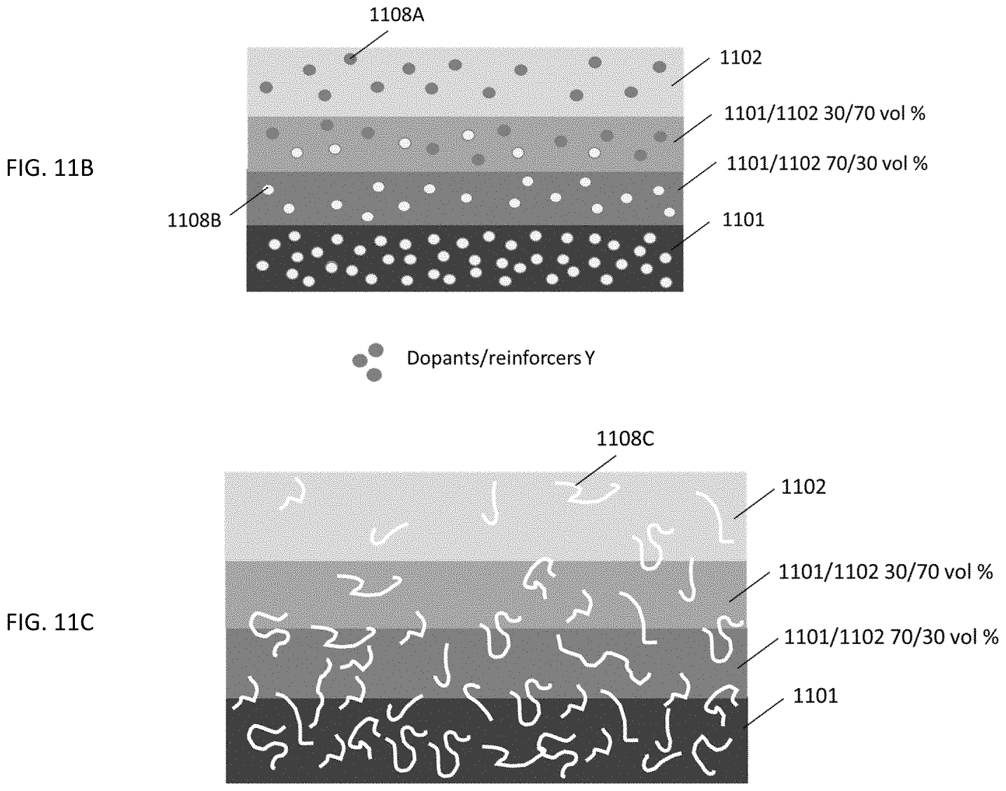

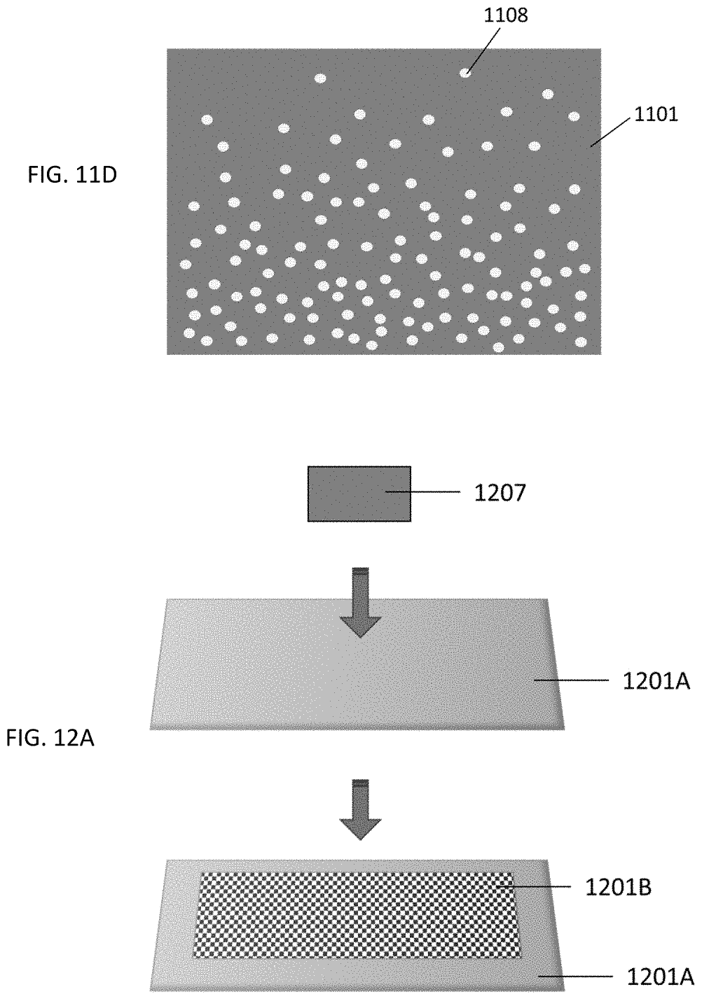

In some embodiments, in addition to the basic matrix material compositional changes in the direction of increasing number of deposited layers, e.g. depositing the layers metal 1101, metal/polymer blends 1101/1102 70/30 vol % and 1101/1102 30/70 vol % and then polymer layer 1102, the concentration of the added dopants (reinforcing particles or fibers) 1108 is changing as well, as presented in FIG. 11A. The metal/polymer blends can be in the range of 5/95 vol % to 95/5 vol %, such as 10/90 vol % to 90/10 vol %, or 20/80 vol % to 80/20 vol %, or such as 30/70 vol % to 70/30 vol %, or 40/60 vol % to 60/40 vol % or 50/50 vol %, or any range within any one or more or combinations of these ranges and/or endpoints.

In other embodiments, the dopants/reinforcers' type and concentration can be tailored throughout the deposited layers. As example only, two different functional dopants or reinforcers 1108A and 1108B are added in the materials, metal 1101 and polymer 1102, joined via metal/polymer blends 1101/1102 70/30 vol % and 1101/1102 30/70 vol % as presented in FIG. 11B. The metal/polymer blends can be in the range of 5/95 vol % to 95/5 vol %, such as 10/90 vol % to 90/10 vol %, or 20/80 vol % to 80/20 vol %, or such as 30/70 vol % to 70/30 vol %, or 40/60 vol % to 60/40 vol %, or 50/50 vol %, or any range within any one or more or combinations of these ranges and/or endpoints.

In situ tailoring of the dopant/reinforcement particles 1108A and 1108B concentrations is done during the solid-state additive manufacturing process in order to provide targeted properties in the top layers of the 3D structure built by the solid-state additive manufacturing process, e.g. to provide anti-corrosion, anti-wear, acoustic protection or anti-microbial activity. As an example, reinforcer 1108B provides the impact strength of the structure, while the dopant 1108A provides the desired anti-corrosion or anti-wear or anti-microbial functionality on the surface of the built structure.

In another embodiment, the gradient in the reinforcing fibers (glass-, carbon, metal-, polymer-, composite-fibers, CNTs, etc.) is achieved in addition to the functionally-graded layers comprising metal layer 1101, metal/polymer blend layers 1101/1102 70/30 vol % and 1101/1102 30/70 vol % and top polymer layer 1002 (FIG. 11C). The metal/polymer blends can be in the range of 5/95 vol % to 95/5 vol %, such as 10/90 vol % to 90/10 vol %, or 20/80 vol % to 80/20 vol %, or such as 30/70 vol % to 70/30 vol %, or 40/60 vol % to 60/40 vol %, such as 50/50 vol %, or any range within any one or more or combinations of these ranges and/or endpoints.

In yet another embodiment, the dopant/reinforcer 1108 concentration changes occur within a single deposited layer 1101, where there are no changes in the basic matrix material (FIG. 11D).

In some embodiments, the dopant/reinforcing particles/fibers' concentration is changed along the direction of added layers yielding a positive concentration gradient. In yet another embodiment, the dopant/reinforcing particles/fibers' concentration is changed along the direction of added layers yielding a negative concentration gradient.

In some embodiments, the functionality of the deposited layers is achieved via the basic material prepared prior to the solid-state additive manufacturing process or in situ during the deposition process.

As example only, metal particles are added to a polymer powder or granular material during the solid-state additive manufacturing process. Depending on the metal type and concentration, the deposited polymer layer has certain functionalities, which are different than those of the basic polymer material. In one case, the layer made of a polymer in situ mixed with Cu particles, and consequently, deposited by way of the solid-state additive manufacturing process, exhibits anti-microbial activity in addition to increasing the thermal and electrical conductivity of the polymer layer. In another example, a polymer layer with metal particles or reinforcers could partially replace heavy metal structures and still have properties similar to the metal counterparts. In some embodiments, antimicrobial coatings are fabricated by in situ mixing of metal or polymer material with Ag or Cu nano-particles and deposited on a substrate. This approach is of particular interest in industries, like the ship-manufacturing industry, where the ship surface has to be resistant to biofilm formation.

In some embodiments, corrosion protection of metal surfaces is achieved by solid-state additive manufacturing deposition of a conductive polymer layer. In yet another embodiment, the anticorrosion functionality of the metal surface is achieved by depositing a non-conductive polymer.

In some embodiments, scratch-resistant top layer is achieved by depositing a self-healing polymer layer. As example only, a self-healing polymer usually contains microcapsules filled with photo-initiator and monomer. In a case of a scratch or cut on the surface of self-healing layer, the microcapsule(s) break and the initiator reacts under UV and/or visible light and cross-link the monomers, thus providing a polymer filling in the layer's scratch/cut.

In some embodiments, anti-wear layers or coatings are deposited by the solid-state additive manufacturing process. In another embodiments, shock-absorbent layers are deposited via solid-state additive manufacturing process between two metallic or composite layers. In one embodiment, the shock-absorbent layer is an elastomer.

In one embodiment, the solid-state additive manufacturing coating deposited is a Teflon-like coating. The fluoro-polymer coatings (known as “dry film lubricants”) are hard and slick coatings with excellent corrosion- and chemical resistance and are non-stick coatings that significantly reduce friction and abrasion resistance.

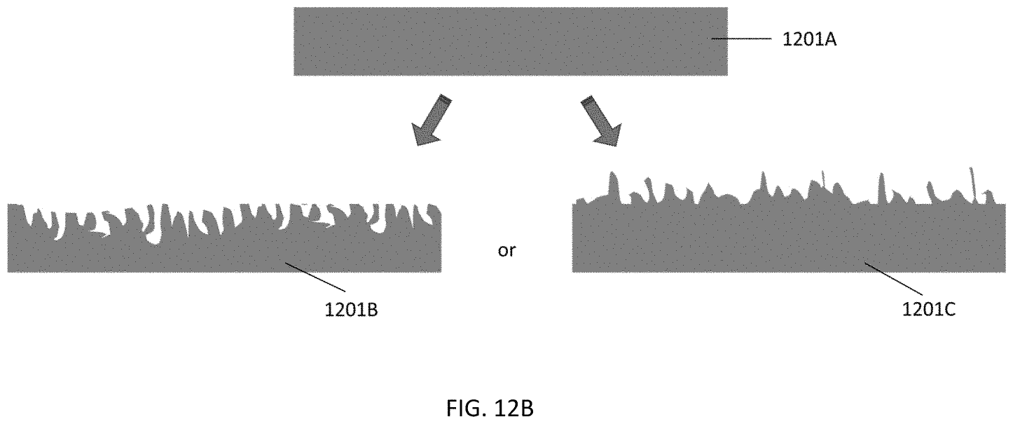

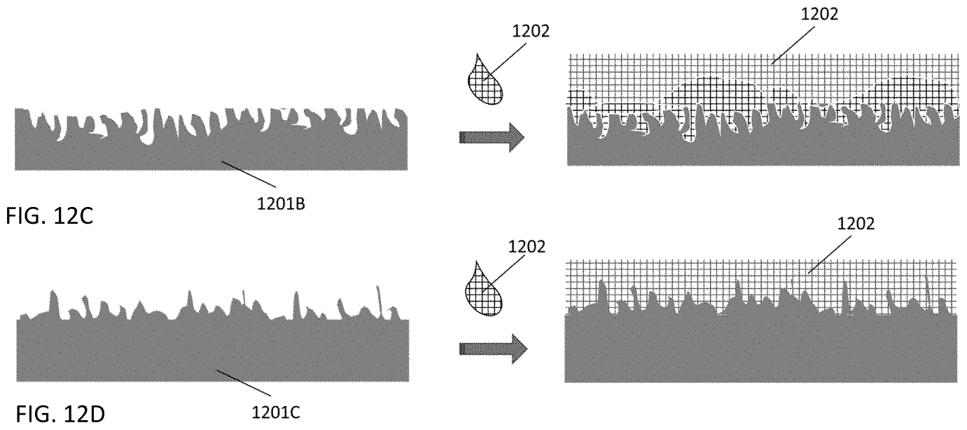

In some embodiments, the parts' surfaces to be joined by the solid-state process(es) are not previously treated. In other embodiments, one or both surfaces of the parts needed to be joined are subjected to treatment (e.g. physical or chemical), including but not limited to: plasma etching, laser etching, reactive ion etching (RIE), corona treatment, flame treatment, ozone treatment, grafting, chemical etching (acid etching) or functionalization, etc., provided by the source 1207, thus the untreated surface 1201A of the part to be joined transforms into treated surface or coating 1201B, as presented in FIG. 12A. The surface treatment usually provides increased surface roughness on a micron- and/or nano-scale. Depending on the type of the treatment, the initial surface 1201A surface roughness can be etched into the surface resulting in a surface 1201B or the surface treatment can be “added” on top of the surface, e.g. surface functionalization 1201C, as it is schematically shown in FIG. 12B. Consequently, the generated surface roughness 1201B or 1201C will provide better bonding of the dissimilar material 1202 deposited on top of the treated surface (FIGS. 12C and 12D).

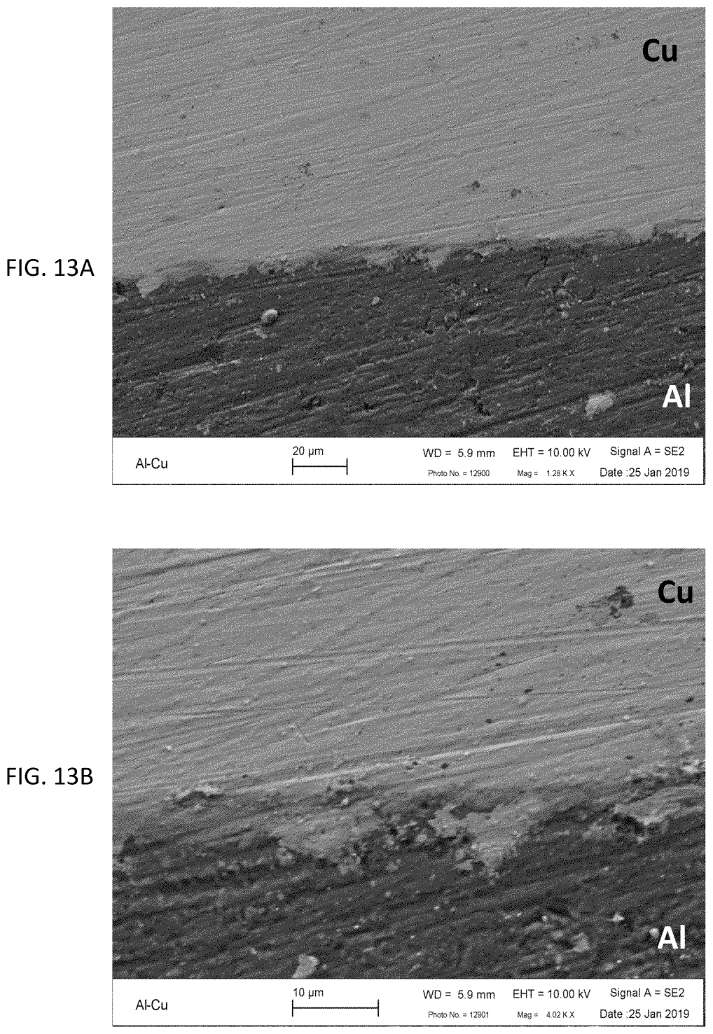

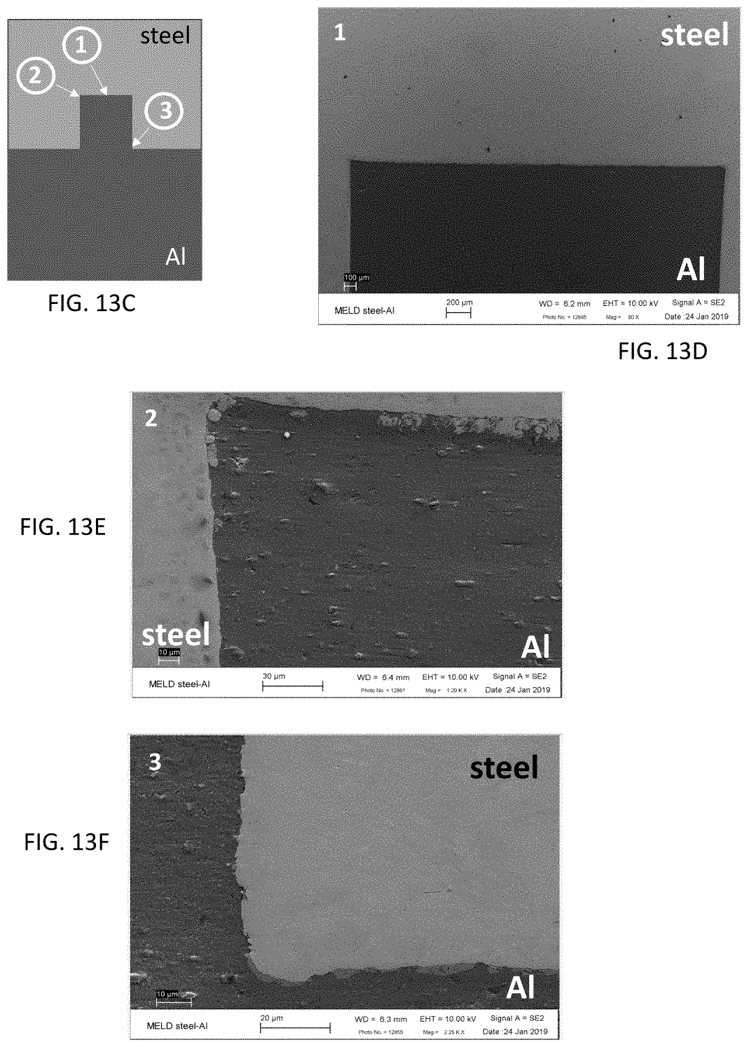

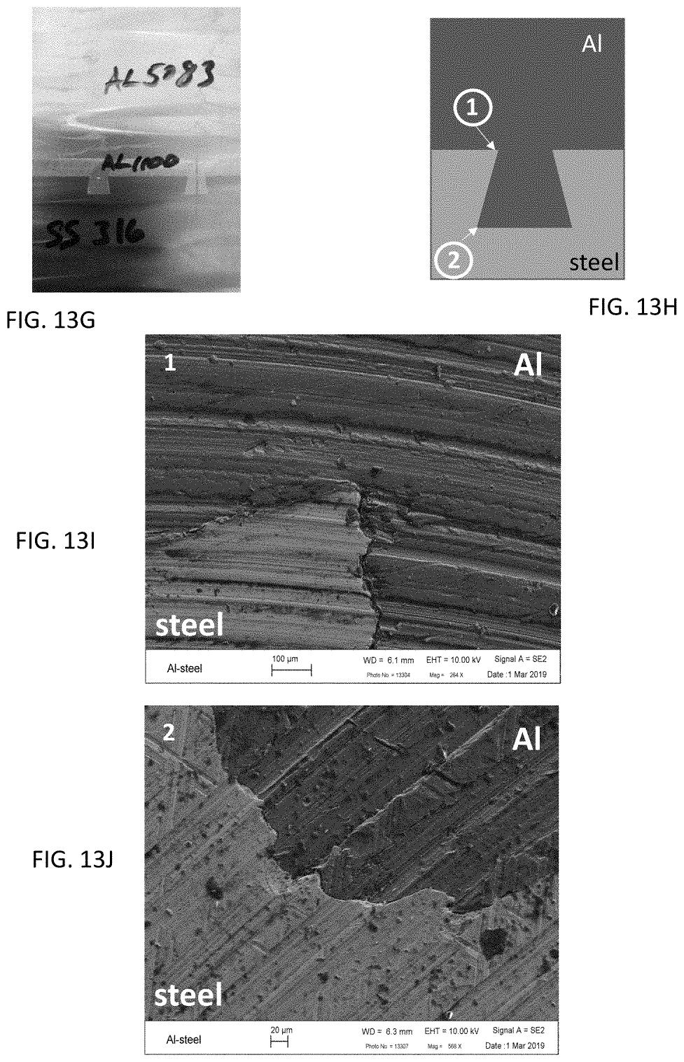

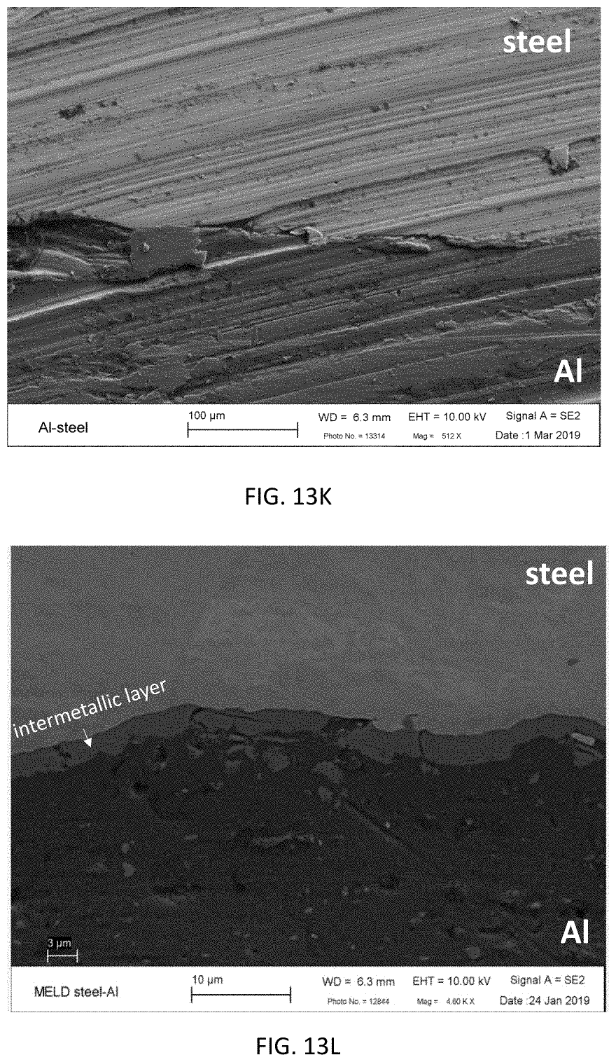

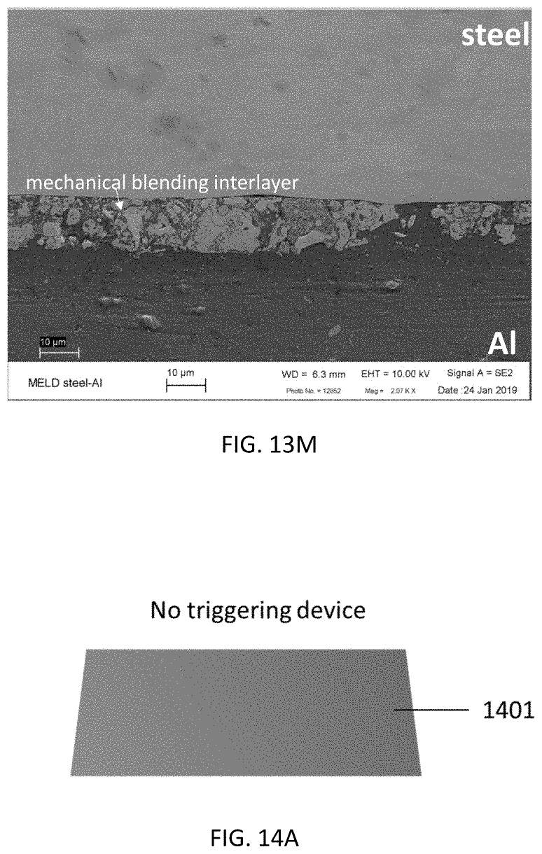

In particular embodiment, copper (Cu) layer is joined to an aluminum (Al) layer by solid-state additive manufacturing. The Al layer is deposited first, and when the required thickness is achieved, the deposition of the Cu layer occurs. Scanning electron microscope (SEM) images of Cu—Al interface of MELD™ type deposited layers are given in FIGS. 13A and 13B.

In another embodiment, steel and aluminum (Al) are joined via interlocks. SEM images of steel-Al interface around the square type interlock are presented in FIGS. 13C, 13D, 13E and 13F. In other embodiments, steel and Al are joined via dovetail type interlock as presented in FIGS. 13G, 13H, 12I and 13J.

In some embodiments, the joint between two different materials is “direct” as presented in the SEM image in FIG. 13K for steel-Al. In other embodiments, by adjusting the MELD™ type processing conditions, the joint between two materials involves formation of an intermetallic layer, as presented with the SEM image for steel-Al in FIG. 13L. In yet another embodiment, the joint between two materials involves mechanical mixture of both materials as an interlayer, as presented with the SEM image for steel-Al given in FIG. 13M.

Furthermore, the following provides certain Aspects of the taggants incorporation in deposited layers, but should not be construed as limiting.

Aspect 1A. A MELD™ type 3D printed layer or object, or method of manufacture thereof, where the layer or object comprises at least one taggant that uniquely responds to an external triggering of a reading device, and thus, the layer originality can be verified.

Aspect 2A. The layer, object, or method of Aspect 1, where the layer originality is verified with a light source generating light of certain wavelengths.

Aspect 3A. The layer, object, or method of any preceding Aspect, where the layer originality is verified with a heat-generating source.

Aspect 4A. The layer, object, or method of any preceding Aspect, where the layer originality is verified with an electric field generating device.

Aspect 5A. The layer, object, or method of any preceding Aspect, where the layer originality is verified by a magnetic field generating device.

Aspect 6A. The layer, object, or method of any preceding Aspect, where the layer originality is verified by a microscope.

Aspect 7A. The layer, object, or method of any preceding Aspect, where the layer is deposited in continuous solid-state additive manufacturing process by continuous mixing the taggant(s) with the feedstock material and their subsequent deposition.

Aspect 8A. The layer, object, or method of any preceding Aspect, where the layer is deposited in a continuous solid-state additive manufacturing process by adding taggant(s) to the feedstock material at certain time periods.

Aspect 9A. The layer, object, or method of any preceding Aspect, where the layer is deposited in a discontinuous (batch) solid-state additive manufacturing method by adding taggant(s) in particular batches to the feedstock material.

Aspect 10A. The layer, object, or method of any preceding Aspect, where the taggant is in situ generated during solid-state additive manufacturing deposition.

Aspect 11A. The layer, object, or method of any preceding Aspect, where the taggant is generated by physical bonding or complexation of the components added in the solid-state additive manufacturing system.

Aspect 12A. The layer, object, or method of any preceding Aspect, where the taggant is generated by a chemical reaction among components added in the solid-state additive manufacturing system.

Aspect 13A. The layer, object, or method of any preceding Aspect, where the layer comprises an inert taggant that is activated by an external device.

Aspect 14A. The layer, object, or method of any preceding Aspect, where the layer comprises an inert taggant that is activated by applying external chemical(s).

Aspect 15A. The layer, object, or method of any preceding Aspect, where the layer comprises one, two or more taggants in a particular order along the deposited layer.

Aspect 16A. The layer, object, or method of any preceding Aspect, where the layer comprises one, two or more taggants, which are activated only in conjunction/concert with the taggant(s) in the subsequent and/or underneath layers.

Aspect 17A. The layer, object, or method of any preceding Aspect, where the layer comprises one, two or more taggants with multiple levels of security.

Aspect 18A. The layer, object, or method of any preceding Aspect, where a single taggant responds to multiple readers (detectors) to reveal the hidden information.

Aspect 19A. The layer, object, or method of any preceding Aspect, where two or more taggants are present, which upon triggering by a single reader reveal multiple levels of secured information.

Aspect 20A. The layer, object, or method of any preceding Aspect, where two or more taggants reveal multiple levels of secured information upon being triggered by two or more reading devices.

Aspect 21A. The layer, object, or method of any preceding Aspect, where the layer comprises a phosphor-type taggant(s).

Aspect 22A. The layer, object, or method of any preceding Aspect, where the layer comprises strontium aluminate doped with rare earth metal.

Aspect 23A. The layer, object, or method of any preceding Aspect, where the layer comprises up converting phosphor(s).

Aspect 24A. The layer, object, or method of any preceding Aspect, where the layer comprises taggants with blue light emission upon light excitation.

Aspect 25A. The layer, object, or method of any preceding Aspect, where the layer comprises taggant(s) with green light emission upon light excitation.

Aspect 26A. The layer, object, or method of any preceding Aspect, where the layer comprises taggant(s) with red light emission upon light excitation.

Aspect 27A. The layer, object, or method of any preceding Aspect, where the layer comprises taggant(s) with white light emission upon light excitation.

Aspect 28A. The layer, object, or method of any preceding Aspect, where the layer comprises taggant(s) with yellow light emission upon light excitation.

Aspect 29A. The layer, object, or method of any preceding Aspect, where the layer comprises taggant(s) with orange light emission upon light excitation.

Aspect 30A. The layer, object, or method of any preceding Aspect, where the layer comprises taggant(s) with indigo (purple) light emission upon light excitation.

Aspect 31A. The layer, object, or method of any preceding Aspect, where the layer comprises taggant(s) with multiple-color light emission upon light excitation.

Aspect 32A. The layer, object, or method of any preceding Aspect, where the layer comprises distributed taggants in a controlled fashion, which upon light excitation will emit colors in a particular pattern.

Aspect 33A. The layer, object, or method of any preceding Aspect, where the layer comprises taggant(s) that will act in concert with the other layers revealing specific color pattern.

Aspect 34A. The layer, object, or method any preceding Aspect, where the layer comprises photochromic taggant(s).

Aspect 35A. The layer, object, or method of any preceding Aspect, where the layer comprises thermochromic taggant(s).

Aspect 36A. The layer, object, or method of any preceding Aspect, where the layer comprises electrochromic taggant(s).

Aspect 37A. The layer, object, or method of any preceding Aspect, where the layer comprises two of more taggants that upon a certain triggering action react and exhibit special effects.

In particular embodiments, only one type of taggant is used in a particular section (layer) of the final part built by solid-state additive manufacturing or throughout the whole object (part) built by the solid-state additive manufacturing process.

In other embodiments, two or more taggants are used in the part built by the solid-state additive manufacturing process. The taggants can be mixed together and distributed throughout the particular deposited layer or can be distributed throughout the whole part.

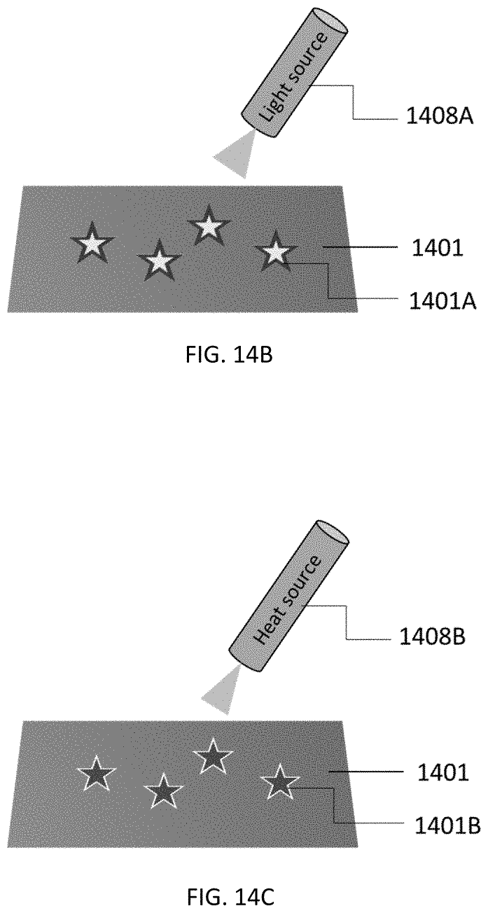

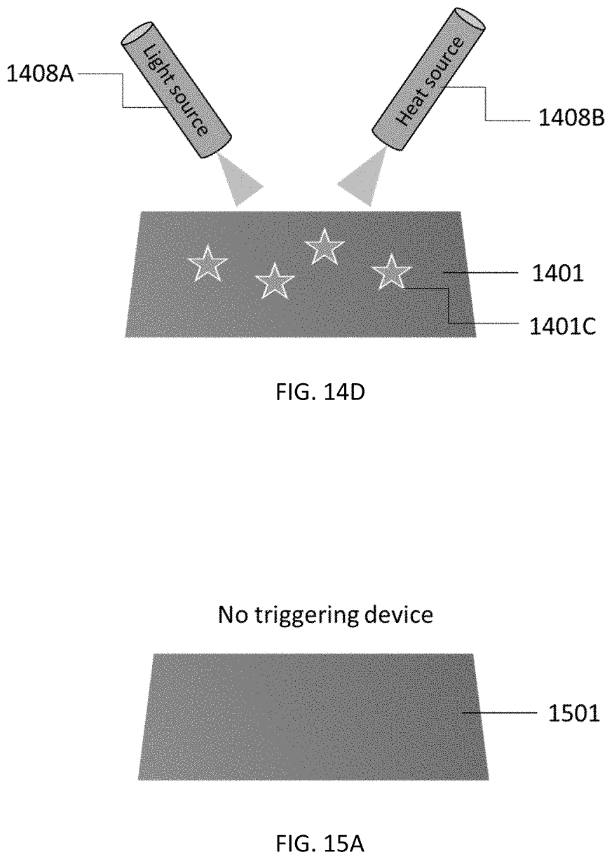

In some embodiments, to overcome the disadvantages of a single taggant use or single security application level, multi-level security solutions and/or multiple taggants are used. For instance, in one embodiment the taggant is “invisible” in the deposited layer 1401, if an external triggering/detecting action is not present (FIG. 14A). The taggant responds in a certain way 1401A, when exposed to a light of certain wavelength (FIG. 14B) triggered by light source 1408A, it responds in a different way 1401B when exposed to a heat (elevated temperature) supplied by a heat source 1408B (FIG. 14C), and yet responds in a third way 1401C, when exposed simultaneously to light of certain wavelength supplied by a light source 1408A and heat supplied by heat source 1408B (FIG. 14D). Multiple types of taggants can also be used to provide desired responses to selected stimuli.

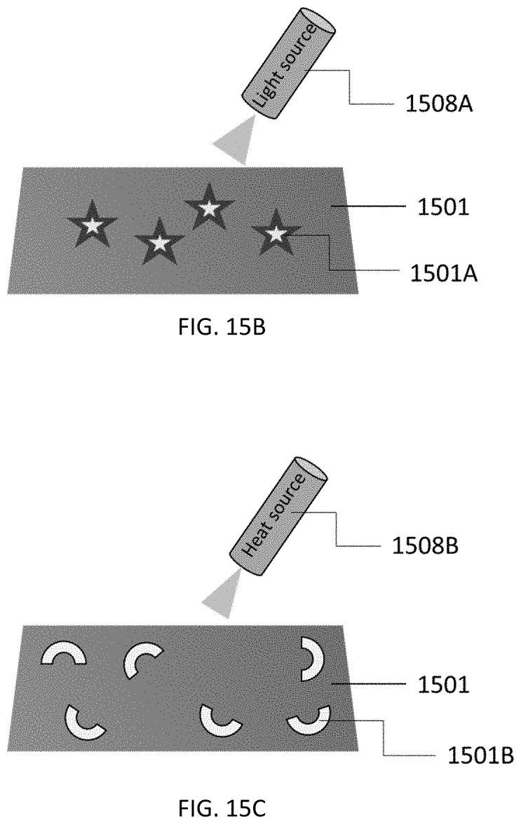

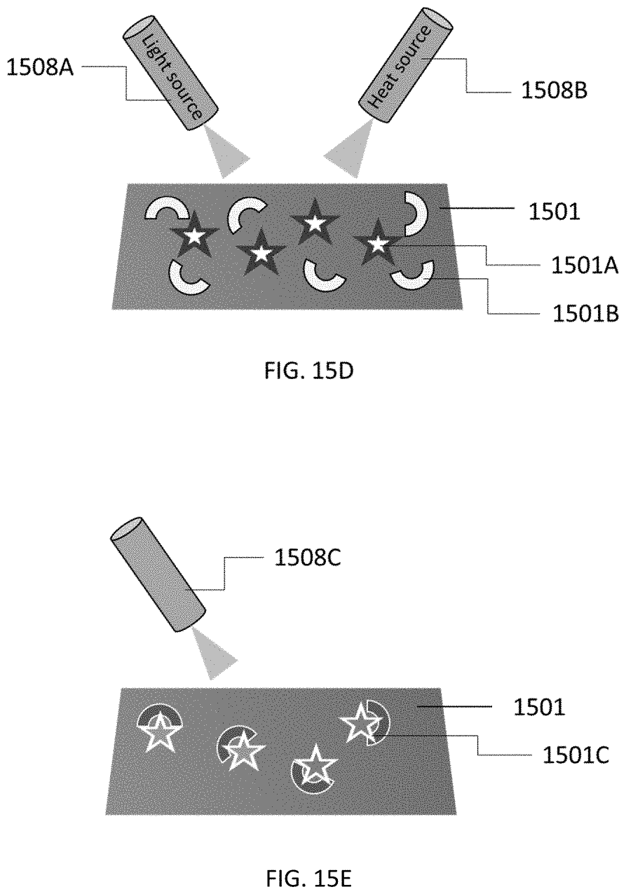

In another embodiment, two taggants are used, which are “invisible” in the deposited layer 1501, when there is no triggering action present (FIG. 15A). When triggering occurs, e.g. with exposure to certain light by a light source 1508A, only one taggant shows its effect 1501A (FIG. 15B). Under a different triggering action, e.g. at elevated temperature supplied by a heat source 1508B, the second taggant shows its effects 1501B (FIG. 15C), and when both triggering actions are present (light+heat) supplied by the sources 1508A and 1508B, both taggants exhibit their effects 1501A and 1501B (FIG. 15D). Under a very different triggering action 1508C, the both taggants show effects 1501C very different effects than the ones previously exhibited or may react together and show the effect 1501C (FIG. 15E).

The light source used to trigger the taggant can be a lamp (such as a UV, visible, or infrared lamp), a light emitting diode, or a laser. The UV lamp can emit light in UV-A, UV-B, or UV-C bands. The laser can be chosen to emit one or more wavelengths anywhere from ultraviolet to infrared spectral range.

Non-limiting categories of laser sources include solid-state lasers, gas lasers, excimer lasers, dye lasers, and semiconductor lasers. An excimer laser is a non-limiting example of a laser emitting at ultraviolet frequencies, while a CO2 laser is a non-limiting example of a laser emitting at infrared frequencies. The choice of the laser will depend on the particular wavelength of light emitted and its relative absorption by the taggant(s). In one embodiment, the laser is a tunable laser which allows adjustment of the output wavelength. Descriptions of various laser sources are available in the art including Thyagarajan, K., Ghatak, Ajoy, Lasers: Fundamentals and Applications, Springer US, 2011, ISBN-13:9781441964410, incorporated by reference herein, as well as The Encyclopedia of Laser Physics and Technology (available online at https://www.rpphotonics.com/encyclopedia.html).

The heat source used to trigger the taggant(s) can be any object that produces or radiates heat, such as an infrared lamp, electrical heating element, flame, combusting materials, waste heat sources, and the like.

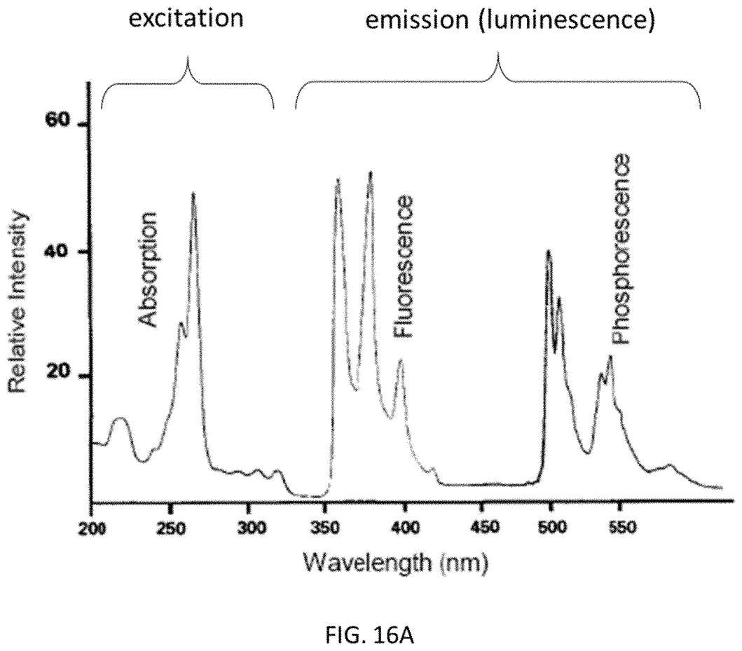

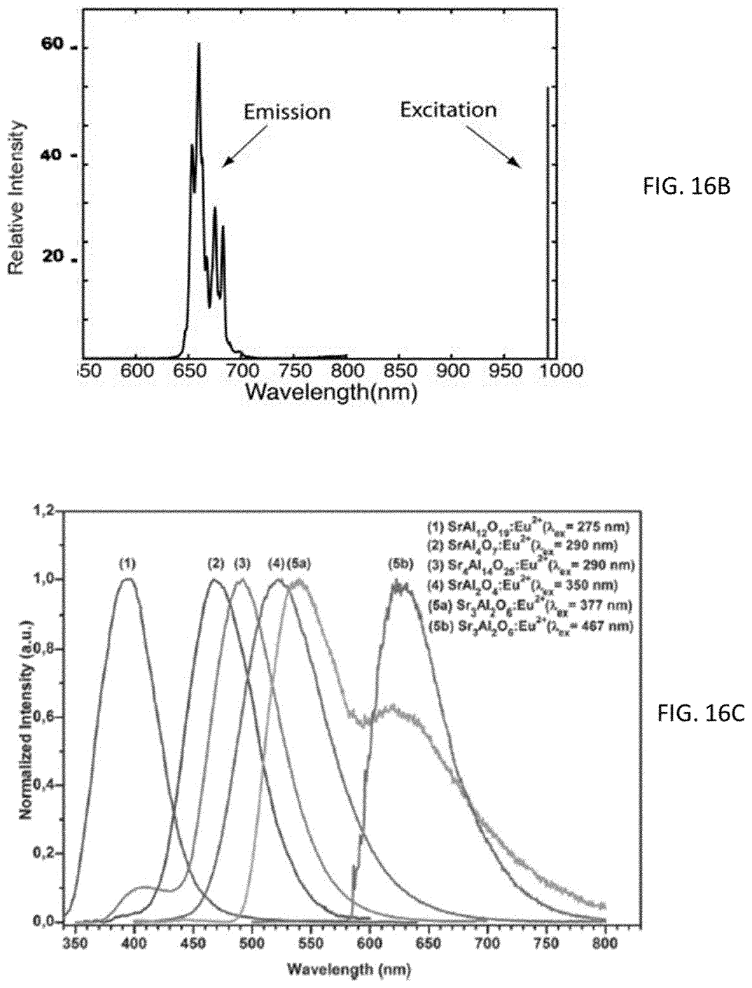

In particular embodiments, a phosphor material or a combination of two or more phosphors are used as taggants. Phosphor, in general, is a material that exhibits luminescence, which term covers both, phosphorescence and fluorescence (FIG. 16A). Phosphors are often consisting of transition metal compounds or rare-earth compounds used as dopants in a matrix (host) material.

In other embodiments, up-converting phosphors are used as taggants. Up-converting phosphors are microscopic ceramic powders that convert invisible infrared light wavelengths to visible colored light (FIG. 16B). For instance, up-converting phosphors can emit visible green, red, orange or blue colors, when triggered with an infrared light (e.g. IR laser pen). There is an anti-stokes shift that separates emission peaks from the infrared excitation peak. Essentially, these taggants light up when hit with an infrared light. In combination with other taggant technologies, they can be utilized as a step in a multi-level security solution. The mechanism behind the up-converting phosphors is the so-called up-conversion, where the sequential absorption of two or more photons results in the light emission at shorter wavelength than the excitation wavelength. It is also known as anti-Stokes emission and therefore the materials are known as anti-Stokes phosphors. Example is excitation with IR light and emission in the visible spectral range. Lanthanide-doped materials, such as fluorides NaYF4, NaGdF4, LiYF4, YF3, CaF2 or oxides such as Gd2O3 are doped with certain amounts of lanthanide ions. The most common lanthanide ions used in photon up-conversion are the pairs erbium-ytterbium (Er3+,Yb3+) or thulium-ytterbium (Tm3+, Yb3+). Usually ytterbium ions are added to absorb light at around 980 nm and transfer it to the upconverter ion. If the upconverter ion is erbium, then a characteristic green and red emission is observed, while when the upconverter ion is thulium, the emission includes near ultraviolet, blue and red light.

An example of a phosphor material is strontium aluminate (SrAl2O4), which can be “activated” with a suitable dopant, e.g. europium (SrAl2O4:Eu), and then it can act as a phosphor with long persistence of phosphorescence. Besides strontium aluminate, other aluminates can be used as the host matrix for the rare-earth or transition-metal dopants. The matrix (as well as the dopant) affects the emission wavelength of the dopant ion. In general, strontium aluminate phosphors produce green and blue emissions with excitation wavelengths ranging from 200 to 450 nm. The wavelength for its green emission is 520 nm, its aqua or blue-green emission is at 505 nm, and the blue version emits at 490 nm. For europium-dysprosium doped aluminates, the peak emission wavelengths are 520 nm for SrAl2O4, 480 nm for SrAl4O7, and 400 nm for SrAl12O19. Cerium- and manganese-doped strontium aluminate (SrAl12O19:Ce,Mn) shows intense narrowband phosphorescence at 515 nm, when excited by ultraviolet light.

In some embodiments, a variety of strontium aluminates are used and more specifically the Eu doped Sr-aluminates. Several emission spectra of Eu-doped strontium aluminates are given in FIG. 16C, where the emitted visible color ranges from purple, blue, green, orange to red.

In other embodiments, other types of phosphors are used as taggants in the solid-state additive deposits, such as but not limited to:

YAlO3:Ce (YAP), blue emission (370 nm)

Y2SiO5:Ce (P47), blue emission (400 nm)

CdWO4, blue emission (475 nm)

ZnO:Zn (P15), blue emission (495 nm)

CdS:In, green emission (525 nm)

Y3A15012:Ce (YAG), green emission (550 nm)

Zn(0.5)Cd(0.4)S:Ag (HS), green emission (560 nm)

LiF/ZnS:Cu,Al,Au (NDg), green emission (565 nm)

Gd2O2S:Eu, red emission (627 nm)

Zn(0.4)Cd(0.6)S:Ag (HSr), red emission (630 nm)

MgWO4, white emission (500 nm)

Y2O2S:Pr, white emission (513 nm), etc.

In some embodiments, and especially for military applications, among different taggant materials and devices, those emitting in the Infrared (IR) region or identified with IR-light are especially important classes of covert taggants. Infrared (IR) light is part of the electromagnetic radiation with wavelengths ranging from 0.75 μm to 1000 μm. For military applications, the IR wavelength is usually limited to 15 μm.

Certain materials can emit IR light through chemiluminescence, photoluminescence or electro-luminescence. There are three general groups of IR emitting materials: organic IR emitting dyes, lanthanide IR emitters, and semiconductor IR emitters. Many organic dyes have been developed especially for NIR bimolecular imaging and common organic NIR fluorophores include cyanine, oxazine and rhodamine dyes. The emission/fluorescence peaks of these dyes are between 700-850 nm. Organic dyes with fluorescence maxima extending to far near IR and into short wave IR can be achieved by the formation of metal ion complexes. The most notable group of metals whose ions are capable of narrow band infrared emission is the lanthanide series with atomic numbers 57 to 71 (lanthanum to lutetium). Lanthanide infrared phosphors can also be hosted in inorganic matrices. These inorganic host materials include fluoride and oxyfluoride optical glasses, such as NaYF, SiO2-Al2O3-NaF—YF3, and oxide glass/ceramics including SiO2, ZrO2, Y2O3, and Y3Al5O12 (yttrium aluminum garnet; YAG). These inorganic host materials are generally optically transparent, especially in the IR spectral region. Infrared emissions of lanthanide are often achieved through photoluminescence. Well known IR emission wavelengths from lanthanide ions are generally in the 1-3 μm regions, but also there are known several trivalent lanthanide ions that have possible emission transitions in the 3-5 μm spectral region.

In a certain embodiment, the MELD™ type solid-state additive deposits are containing up-converting phosphors that are especially useful in night searching for materials or objects with IR light.

In some embodiments, microfibers, e.g. carbon fibers, or chopped microfibers, are embedded in objects produced by a solid-state additive manufacturing process and used as taggants, where the particular fiber morphology can be distinguished with a more sophisticated detector, e.g. with a microscope.

In a certain embodiment, photochromic taggant(s) are incorporated in MELD™ type deposited layers or parts. The taggant responds by changing a color or appearance of color upon exposure to light of certain wavelengths.

In another embodiment, thermochromic taggant(s) are incorporated in MELD™ type deposited layers or parts. The taggant responds by appearance of color or changing a color upon exposure to heat.

In yet another embodiment, electrochromic taggant(s) are incorporated in MELD™ type deposited layers or parts. The taggant responds by appearance of color or changing a color upon electric field is applied to the layer/part, which is very useful for conductive parts.

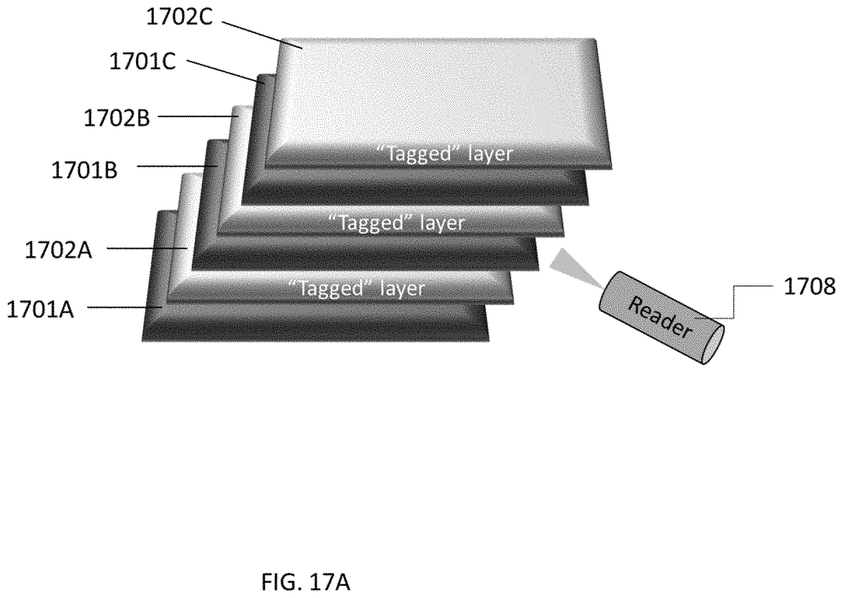

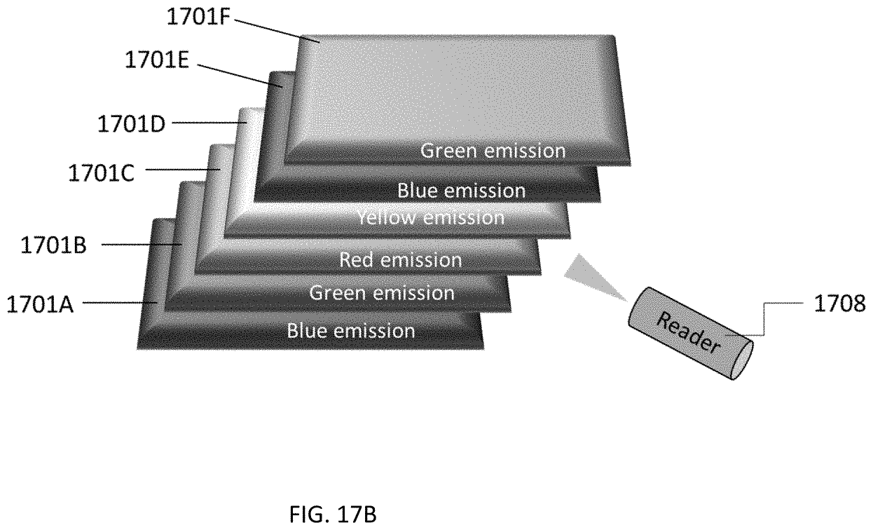

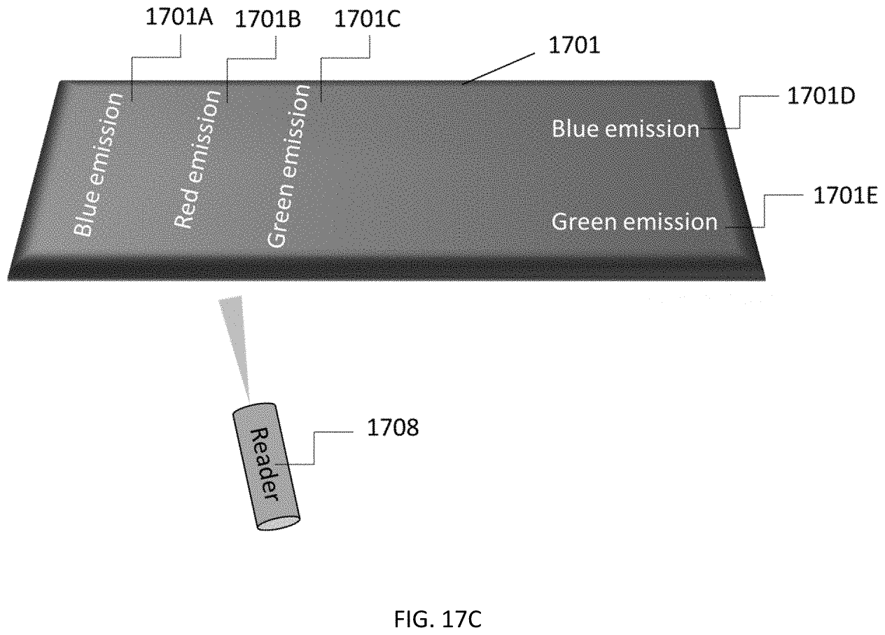

In some embodiments, the taggant is added only in specific layer(s) during the solid-state additive manufacturing deposition (FIG. 17A). In other embodiments, the taggant is added in all the layers, which compose the object produced by the solid-state additive manufacturing process.

In yet another embodiment, each taggant is applied in a different layer of the structure in a particular sequence. In the authentication (checking) step, the particular sequence of taggants' distribution is verified by use of an authentication (read-out or reader) device, which can be a laser light excitation device in the case of used photochromic taggants, or a heat-generating device in the case of thermo-chromic taggants, or their combination which needs more sophisticated detecting device. In FIG. 17B multiple layers are deposited by a solid-state additive manufacturing process, where each layer contains different phosphors, which upon excitation with IR laser pen emit specific visible colors in a certain sequence of the deposited layers.

In another embodiment, different taggants are added within one layer deposited by a solid-state additive manufacturing process in a specific fashion known to limiting number of people (FIG. 17C). The taggants are detected by scanning the layer with a reader. For instance, different phosphors or up-converting phosphors are distributed in the layer in a sequence that is being revealed upon the layer (part) is excited with the excitation wavelengths that these phosphors/up-converting phosphors respond.

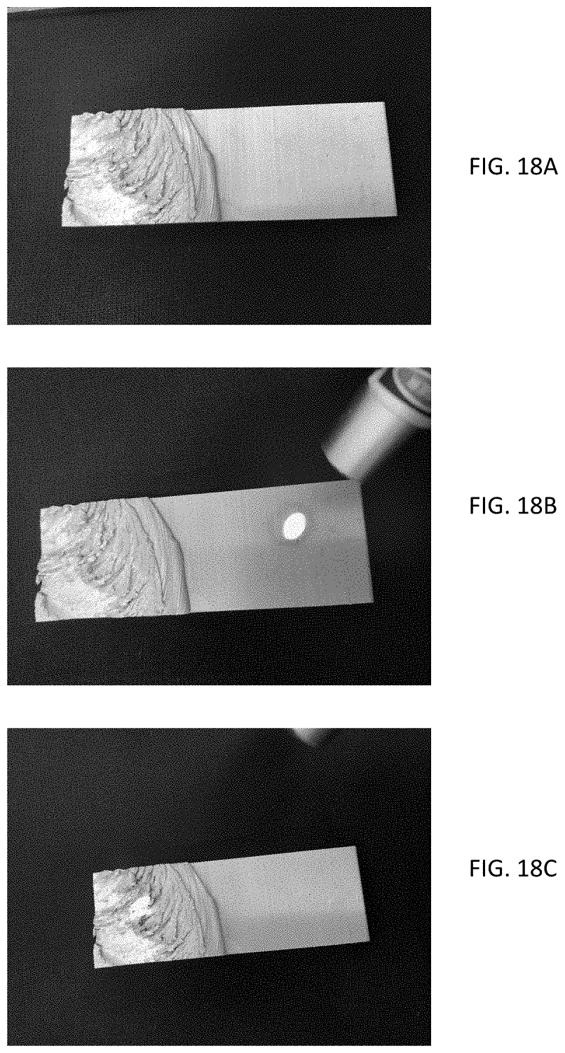

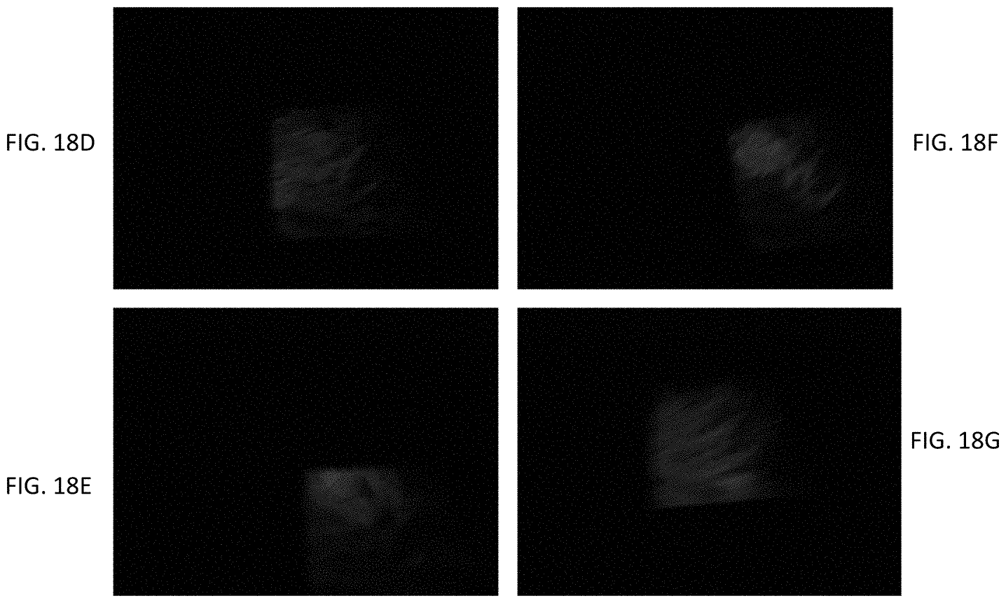

In particular embodiment, a photoluminescent taggant (PL pigment MHB-5BA, Zhejiang Minhui L&T Co.) is added in a solid-state deposited aluminum layer (FIG. 18A). After exposure of the layer or particular zones of the layer with blue light supplied by a laser pen (405 nm wavelength, <5 mW power) for few seconds (FIGS. 18B, 18C) and after discontinuing the light exposure, the layer i.e. the irradiated zone of the layer, emits green light due to the photoluminescent effect (FIGS. 18D, 18E, 18F and 18G).

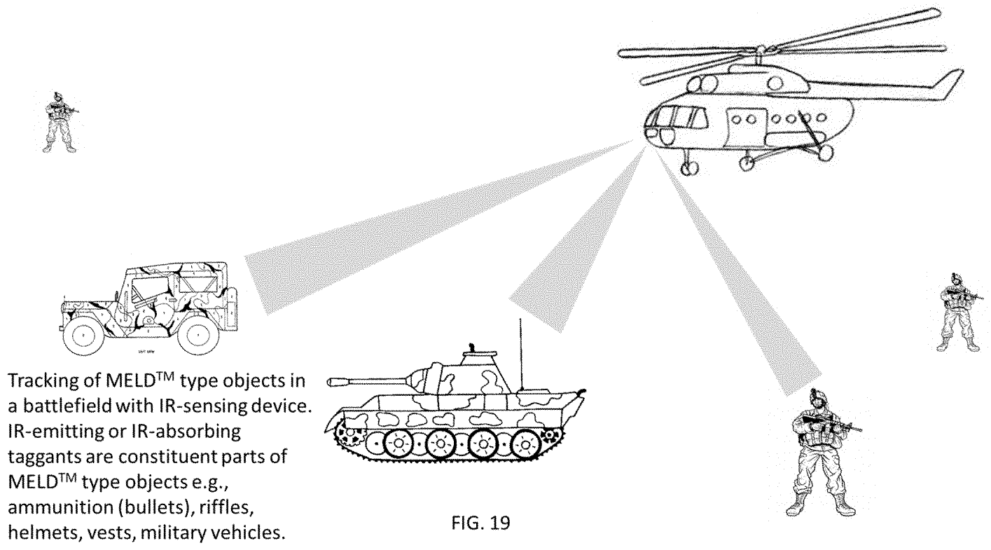

In some embodiments, the embedded taggants in military parts made by the solid-state additive manufacturing process can be sensed with IR-sensing device. As example only, the solid-state-deposited objects that are constituent parts of e.g. ammunition, bullets, helmets, military vehicles, and so on, can be tracked and detected from the air and not left behind for the enemy (FIG. 19).

According to embodiments, the solid-state additive manufacturing machine, tooling and processes may be or include any machine, tool or process described in or depicted in any one or more or combinations of U.S. Application Publication Nos. 2008/0041921, 2010/0285207, 2012/0009339, 2012/0279441, 2012/0279442, 2014/0130736, 2014/0134325, 2014/0174344, 2015/0165546, 2016/0074958, 2016/0107262, 2016/0175981, 2016/0175982, 2017/0043429, 2017/0057204, 2017/0216962, 2018/0085849, 2018/0361501, and International Publication Nos. WO 2013/002869 and WO 2019/089764, which are each hereby incorporated by reference herein in their entirety. According to one embodiment, the solid-state additive manufacturing machine comprises a friction-based fabrication tool comprising: a non-consumable body formed from material capable of resisting deformation when subject to frictional heating and compressive loading and a throat defining a passageway lengthwise through the body and shaped for exerting normal forces on a material in the throat during rotation of the body.

According to another embodiment, the solid-state additive manufacturing machine comprises a non-consumable member having a body and a throat; wherein the throat is shaped to exert a normal force on a consumable material disposed therein for imparting rotation to the coating material from the body when rotated at a speed sufficient for imposing frictional heating of the coating material against a substrate; wherein the body is operably connected with a downward force actuator for dispensing and compressive loading of the consumable material from the throat onto the substrate and with one or more actuators or motors for rotating and translating the body relative to the substrate; wherein the body comprises a surface for trapping the consumable material loaded on the substrate in a volume between the body and the substrate and for forming and shearing a surface of a coating on the substrate.

Other specific embodiments include friction-based fabrication tools comprising: (a) a spindle member comprising a hollow interior for housing a consumable coating or filler material disposed therein prior to deposition on a substrate; wherein the interior of the spindle is shaped to exert a normal force on the consumable material disposed therein for rotating the consumable material during rotation of the spindle; (b) a downward force actuator, in operable communication with the spindle, for dispensing and compressive loading of the consumable material from the spindle onto the substrate and with one or more motors or actuators for rotating and translating the spindle relative to the substrate; and wherein the spindle comprises a shoulder surface with a flat surface geometry or a surface geometry with structure for enhancing mechanical stirring of the loaded consumable material, which shoulder surface is operably configured for trapping the loaded consumable material in a volume between the shoulder and the substrate and for forming and shearing a surface of a coating on the substrate.

In some embodiments, the throat has a non-circular cross-sectional shape. Additionally, any filler material can be used as the consumable material, including consumable solid, powder, or powder-filled tube type coating materials. In the case of powder-type coating material, the powder can be loosely or tightly packed within the interior throat of the tool, with normal forces being more efficiently exerted on tightly packed powder filler material. Packing of the powder filler material can be achieved before or during the coating process. Further provided are tooling configurations comprising any configuration described in this application, or any configuration needed to implement a method according to the invention described herein, combined with a consumable filler material member. Thus, tooling embodiments of the invention include a non-consumable portion (resists deformation under heat and pressure) alone or together with a consumable coating material or consumable filler material (e.g., such consumable materials include those that would deform, melt, or plasticize under the amount of heat and pressure the non-consumable portion is exposed to).

Another aspect of the present invention is to provide a method of forming a surface layer on a substrate, such as repairing a marred surface, building up a surface to obtain a substrate with a different thickness, joining two or more substrates together, or filling holes in the surface of a substrate. Such methods can comprise depositing a coating or filler material on the substrate with tooling described in this application, and optionally friction stirring the deposited coating material, e.g., including mechanical means for combining the deposited coating material with material of the substrate to form a more homogenous coating-substrate interface. Depositing and stirring can be performed simultaneously, or in sequence with or without a period of time in between. Depositing and stirring can also be performed with a single tool or separate tools, which are the same or different. Particular methods include depositing a coating on a substrate using frictional heating and compressive loading of a coating material against the substrate, whereby a tool supports the coating material during frictional heating and compressive loading and is operably configured for forming and shearing a surface of the coating.

In embodiments, the tool and consumable material preferably rotate relative to the substrate. The tool can be attached to the consumable material and optionally in a manner to allow for repositioning of the tool on the coating material. Such embodiments can be configured to have no difference in rotational velocity between the coating material and tool during use. The consumable material and tool can alternatively not be attached to allow for continuous or semi-continuous feeding or deposition of the consumable material through the throat of the tool. In such designs, it is possible that during use there is a difference in rotational velocity between the consumable material and tool during the depositing. Similarly, embodiments provide for the consumable material to be rotated independently or dependently of the tool.

Preferably, the consumable material is delivered through a throat of the tool and optionally by pulling or pushing the consumable material through the throat. In embodiments, the consumable material has an outer surface and the tool has an inner surface, wherein the outer and inner surfaces are complementary to allow for a key and lock type fit. Optionally, the throat of the tool and the consumable material are capable of lengthwise slideable engagement.

Even further, the throat of the tool can have an inner diameter and the consumable material can be a cylindrical rod concentric to the inner diameter. Further yet, the tool can have a throat with an inner surface and the consumable material can have an outer surface wherein the surfaces are capable of engaging or interlocking to provide rotational velocity to the consumable material from the tool. In preferred embodiments, the consumable filler or coating material is continuously or semi-continuously fed and/or delivered into and/or through the throat of the tool. Shearing of any deposited consumable material to form a new surface of the substrate preferably is performed in a manner to disperse any oxide barrier coating on the substrate.

Yet another aspect of the present invention is to provide a method of forming a surface layer on a substrate, which comprises filling a hole in a substrate. The method comprises placing powder of a fill material in the hole(s) and applying frictional heating and compressive loading to the fill material powder in the hole to consolidate the fill material. In yet another embodiment, the MELD™ type machine, in addition to including a tool described in this specification or the Appendices, includes a substrate. Materials that can serve as the consumable filler material or as the substrate(s) can include metals and metallic materials, polymers and polymeric materials, ceramic and other reinforced materials, as well as combinations of these materials. In embodiments, the filler material can be of a similar or dissimilar material as that of the substrate material(s). The filler material and the substrate(s) can include polymeric material or metallic material, and without limitation include metal-metal combinations, metal matrix composites, polymers, polymer matrix composites, polymer-polymer combinations, metal-polymer combinations, metal-ceramic combinations, and polymer-ceramic combinations.

In one particular embodiment, the substrate(s) and/or the filler material are metal or metallic. The filer material, or the substrate(s) can be independently selected from any metal, including for example Al, Ni, Cr, Cu, Co, Au, Ag, Mg, Cd, Pb, Pt, Ti, Zn, or Fe, Nb, Ta, Mo, W, or an alloy comprising one or more of these metals. In embodiments, the substrate(s) and/or the filler material are polymeric material. Non-limiting examples of polymeric materials useful as a filler material include polyolefins, polyesters, nylons, vinyls, polyvinyls, acrylics, polyacrylics, polycarbonates, polystyrenes, polyurethanes, and the like. In still yet another embodiment, the filler material is a composite material comprising at least one metallic material and at least one polymeric material. In other embodiments, multiple material combinations can be used for producing a composite at the interface.

The filler materials can be in several forms, including but not limited to: 1) metal powder or rod of a single composition; 2) matrix metal and reinforcement powders can be mixed and used as feed material; or 3) a solid rod of matrix can be bored (e.g., to create a tube or other hollow cylinder type structure) and filled with reinforcement powder, or mixtures of metal matric composite and reinforcement material. In the latter, mixing of the matrix and reinforcement can occur further during the fabrication process. In embodiments, the filler material may be a solid metal rod. In one embodiment, the filler material is aluminum.

According to embodiments, the filler material and/or the substrate(s) are independently chosen from plastics, homo polymers, co-polymers, or polymeric materials comprising polyesters, nylons, polyvinyls such as polyvinyl chloride (PVC), polyvinylidene chloride (PVDC), polyvinylidene fluoride (PVDF), polyacrylics, polyethylene terephthalate (PET or PETE), Polybutylene terephthalate (PBT), polyamides (PA), Nylons (Ny6, Ny66), polylactide, polycarbonates, polystyrenes, polyurethanes, engineering polymers such as polyetherketone (PEK), polyetheretherketone (PEEK), polyaryletherketone (PAEK), polyetherketoneketone (PEKK), Acrylonitrile butadiene styrene (ABS), Polyphenylene sulfide (PPS), Polysulphone (PSU), polyphenylsulfone (PPSU), Polyphenylene oxide (PPO), Polyphenylene sulfide (PPS), Polyoxymethylene plastic (POM), polyphthalamide (PPA), polyarylamide (PARA), and/or polyolefins such as high density polyethylene (HDPE), low density polyethylene (LDPE), cyclic olefin copolymers (COC), polypropylene, composites, mixtures, reinforcement materials, or a metal matrix composite comprising a metal matrix and a ceramic phase, wherein the metal matrix comprises one or more of a metal, a metal alloy, or an intermetallic, and the ceramic phase comprises a ceramic, and independently chosen from metallic materials, metal matrix composites (MMCs), ceramics, ceramic materials such as SiC, TiB2 and/or Al2O₃, metals comprising steel, Al, Ni, Cr, Cu, Co, Au, Ag, Mg, Cd, Pb, Pt, Ti, Zn, Fe, Nb, Ta, Mo, W, or an alloy comprising one or more of these metals, as well as combinations of any of these materials.

According to one embodiment, any of the taggant(s) described herein are added to or mixed with any of the above filler (also known herein as feedstock) material which is fed through the tool. According to another embodiment, the taggant(s) are layered on top of the substrate prior to deposition of the filler material on top of the substrate. In both cases, the rotating tool of the solid-state additive manufacturing machine mixes the taggant(s) during deposition and plastic deformation of the layer deposited by the solid-state additive manufacturing process.

According to one embodiment, the layer is deposited in continuous solid-state additive manufacturing process by continuous mixing the taggant(s) with the feedstock material and their subsequent deposition.

According to another embodiment, the layer is deposited in a continuous solid-state additive manufacturing process by adding taggant(s) to the feedstock material at certain time periods.

According to another embodiment, the layer is deposited in a discontinuous (batch) solid-state additive manufacturing process by adding taggant(s) in particular batches to the feedstock material.

According to another embodiment, the taggant is in situ generated during solid-state additive manufacturing deposition.

According to another embodiment, the taggant generated by physical bonding or complexation of the components added in the solid-state additive manufacturing system.

According to another embodiment, the taggant is generated by a chemical reaction among components added in the solid-state additive manufacturing system.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the compositions disclosed herein or with any other compositions. Likewise, any of the disclosed compositions can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range, to the tenth of the unit disclosed, is also specifically disclosed. Any smaller range within the ranges disclosed or that can be derived from other endpoints disclosed are also specifically disclosed themselves. The upper and lower limits of disclosed ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

What is claimed is:

1. A process for joining dissimilar materials with a solid-state additive manufacturing machine, comprising:
feeding a first material through a hollow tool of a solid-state additive manufacturing machine onto a surface of a second material;
generating plastic deformation of the first and second material by applying normal, shear and/or frictional forces by way of a rotating shoulder of the hollow tool such that the first and second material are in a malleable and/or visco-elastic state in an interface region, and
mixing and joining the first and second materials in the interface region.

2. The process of claim 1, wherein the first and second materials are two different polymers.

3. The process of claim 1, wherein the first and second materials are two different metals, MMCs or metal alloys.

4. The process of claim 1, wherein the first material is a polymer and the second material is a metal, or the first material is a metal and the second material is a polymer.

5. The process of claim 1, wherein the polymer penetrates among the grains in a surface region of the metal.

6. The process of claim 1, wherein the first material is a polymer and the second material is a composite material, or wherein the first material is a composite material and the second material is a polymer.

7. The process of claim 1, wherein the first material is a metal and the second material is a composite material, or the first material is a composite material and the second material is a metal.

8. The process of claim 1, wherein the first and second materials are unweldable materials.

9. The process of claim 1, wherein the first and second materials are of very low surface energy.

10. The process of claim 1, wherein the first and second materials are joined by way of formation of one or more interlayers.

11. The process of claim 1, wherein the first material is a liquid crystalline polymer (such as an oligomer), which upon deposition on a surface of the second material is preferentially oriented.

12. The process of claim 1, wherein the first material is a reactive material which upon deposition on top of the second material undergoes a reaction.

13. The process of claim 1, wherein the first material undergoes a reaction with the aid of an initiator.

14. The process of claim 1, wherein the first material undergoes a reaction with the aid of heat, light or electron beam.

15. The process of claim 1, wherein one or both of the first and second materials are doped with dopants and/or reinforcement particles.

16. The process of claim 15, wherein the dopants and/or reinforcement particles are of micron- on nano-sizes.

17. The process of claim 15, wherein the dopants and/or reinforcement particles are micron-size or nano-size fibers.

18. The process of claim 15, wherein the dopants and/or reinforcement particles are carbon nanotubes (CNTs).

19. The process of claim 15, wherein the dopants and/or reinforcement particles are mixtures of more than one type of material.

20. The process of claim 15, wherein the dopants are microcapsules filled with initiator, primer and/or adhesion promoter.
